(19) United States
(12) Patent Application Publication
(10) Pub. No.: US 2025/0106817 A1
(43) Pub. Date: Mar. 27, 2025

(54) TRANSMITTING AND RECEIVING A PAGING NOTIFICATION OR ALERT

(71) Applicant: Samsung Electronics Co., Ltd., Suwon-si (KR)

(72) Inventors: Anil Agiwal, Allen, TX (US); Kyeongin Jeong, Allen, TX (US)

(21) Appl. No.: 18/811,692

(22) Filed: Aug. 21, 2024

Related U.S. Application Data
(60) Provisional application No. 63/540,827, filed on Sep. 27, 2023.
(60) Provisional application No. 63/544,713, filed on Oct. 18, 2023.

(51) Int. Cl. H04W 68/02; H04W 24/08

(52) U.S. Cl. CPC H04W 68/02; H04W 24/08

(57) ABSTRACT

A user equipment (UE) includes a transceiver configured to receive a configuration for a paging notification or an alert from a base station of a cell camped on by the UE. The UE also includes a processor operably coupled to the transceiver. The processor is configured to determine whether a downlink signal quality of the camped cell is less than a threshold, and when the downlink signal quality of the camped cell is less than the threshold, monitor a downlink channel of the camped cell for receiving the paging notification or alert.

### CROSS-REFERENCE TO RELATED APPLICATION(S) AND CLAIM OF PRIORITY

This application claims priority under 35 U.S.C. § 119(e) to U.S. Provisional Patent Application No. 63/540,827 filed on Sep. 27, 2023, and U.S. Provisional Patent Application No. 63/544,713 filed on Oct. 18, 2023. The above-identified provisional patent applications are hereby incorporated by reference in their entirety.

### TECHNICAL FIELD

This disclosure relates generally to wireless networks. More specifically, this disclosure relates to transmitting and receiving a paging notification or alert.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatus and methods for transmitting and receiving a paging notification or alert.

In one embodiment, a user equipment (UE) is provided. The UE includes a transceiver configured to receive a configuration for a paging notification or an alert from a base station of a cell camped on by the UE. The UE also includes a processor operably coupled to the transceiver. The processor is configured to determine whether a downlink signal quality of the camped cell is less than a threshold, and when the downlink signal quality of the camped cell is less than the threshold, monitor a downlink channel of the camped cell for receiving the paging notification or alert.

In another embodiment, a base station (BS) is provided. The BS includes a processor, and a transceiver operably coupled to the processor. The transceiver is configured to transmit a configuration for a paging notification or an alert to a UE camped on a cell of the base station, and transmit the paging notification or alert to the UE.

In yet another embodiment, a method of operating a UE is provided. The method includes receiving a configuration for a paging notification or an alert from a base station of a cell camped on by the UE, and determining whether a downlink signal quality of the camped cell is less than a threshold. The method also includes, when the downlink signal quality of the camped cell is less than the threshold, monitoring a downlink channel of the camped cell for receiving the paging notification or alert.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of NTN communication according to embodiments of the present disclosure;

FIG. 5 illustrates an example method for paging transmission and reception according to embodiments of the present disclosure;

FIG. 6 illustrates another example method for paging transmission and reception according to embodiments of the present disclosure;

FIG. 7 illustrates another example method for paging transmission and reception according to embodiments of the present disclosure;

FIG. 8 illustrates an example of UE operation during a measurement gap according to embodiments of the present disclosure; and

FIG. 9 illustrates an example method for transmitting and receiving a paging notification or alert according to embodiments of the present disclosure.

### DETAILED DESCRIPTION

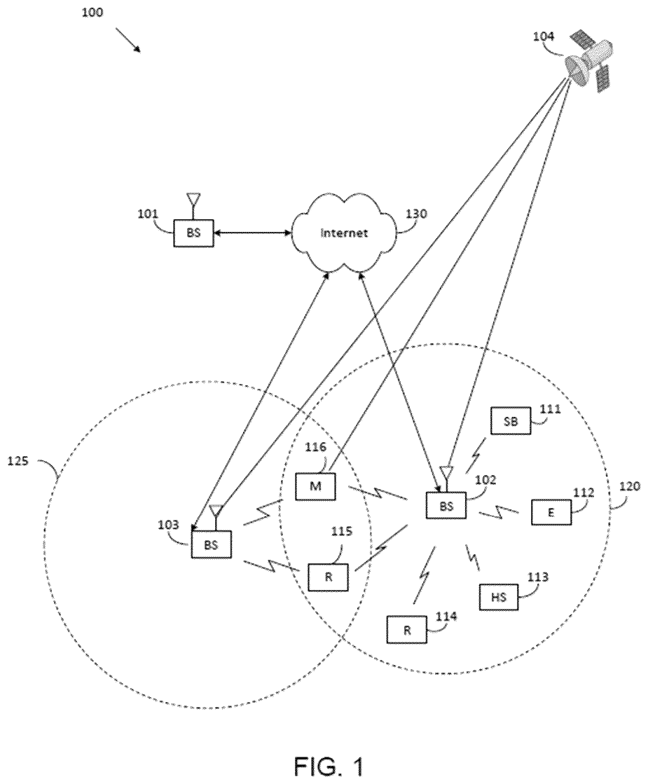

FIGS. 1 through 9, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, for receiving a paging notification or alert. In certain embodiments, one or more of the gNBs 101-103 includes circuitry, programing, or a combination thereof, to support transmitting a paging notification or alert in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

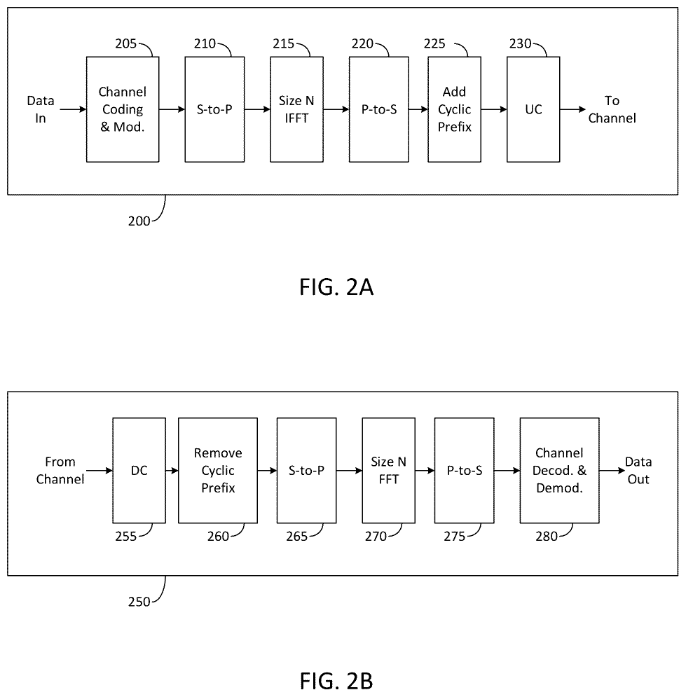

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support transmitting and receiving a paging notification or alert as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

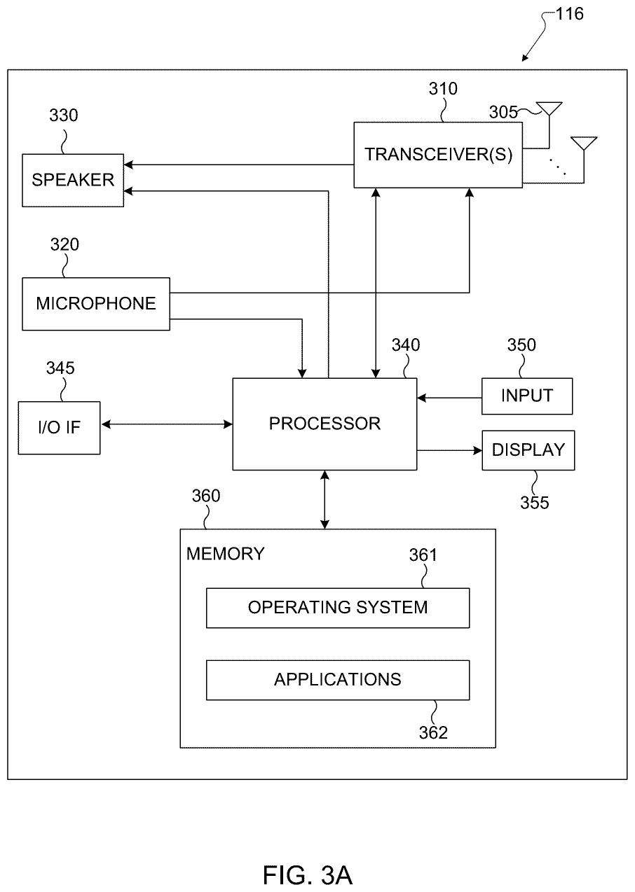

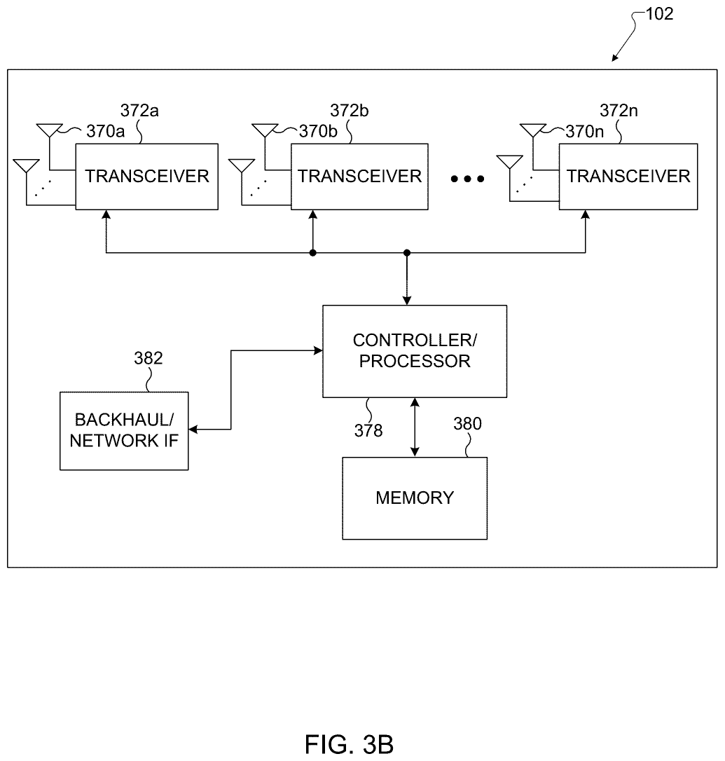

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for receiving a paging notification or alert as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support transmitting a paging notification or alert as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

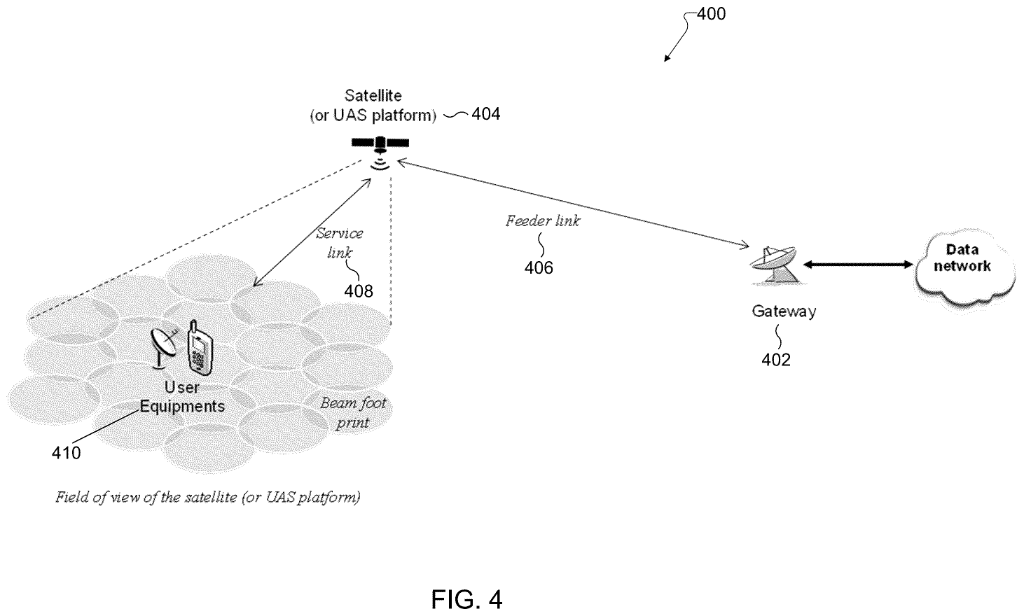

FIG. 4 illustrates an example of NTN communication 400 according to embodiments of the present disclosure. An embodiment of the NTN communication 400 shown in FIG. 4 is for illustration only. Different embodiments of NTN communication could be used without departing from the scope of this disclosure.

In the next generation wireless communication system (e.g., 5G, beyond 5G, 6G), one feature under discussion is a non-terrestrial network (NTN). An NTN refers to a network, or segment of networks using RF resources on board a satellite (or unmanned aircraft system (UAS) platform) as shown FIG. 4. The satellite is also referred as an NTN payload. An NTN typically features the following example elements:

In one example, one or several sat-gateways (or NTN gateways) may connect the NTN to a public data network (e.g., gateway 402 of FIG. 4).

In one example, a geostationary earth orbit (GEO), circular orbit at 35,786 km above the Earth's equator and following the direction of the Earth's rotation) satellite (e.g., satellite 404 of FIG. 4) is fed by one or several sat-gateways which are deployed across the satellite targeted coverage (e.g., regional or even continental coverage). It may be assumed that UEs in a cell are served by only one sat-gateway.

In one example, a non-GEO satellite is served successively by one or several sat-gateways at a time. The system ensures service and feeder link continuity between the successive serving sat-gateways with sufficient time duration to proceed with mobility anchoring and hand-over. A LEO (Low Earth Orbit: orbit around the Earth with an altitude between 300 km, and 1500 km) satellite can be one example.

In one example, a feeder link (e.g., feeder link 406 of FIG. 4) or radio link between a sat-gateway and the satellite (or UAS platform) is provided.

In one example, a service link (e.g., service link 408 of FIG. 4) or radio link between the user equipment (e.g., user equipments 410 of FIG. 4) and the satellite (or UAS platform) is provided.

In one example, a satellite (or UAS platform) may implement either a transparent or a regenerative (with on board processing) payload. The satellite (or UAS platform) typically generates several beams over a given service area bounded by a field of view. The footprints of the beams are typically of elliptic shape. The field of view of a satellite (or UAS platform) depends on the on-board antenna diagram and minimum elevation angle.

In one example, a transparent payload is provided: radio frequency filtering, frequency conversion and amplification. Therefore, the waveform signal repeated by the payload is un-changed.

In one example, a regenerative payload is provided: radio frequency filtering, frequency conversion and amplification as well as demodulation/decoding, switch and/or routing, coding/modulation. This is effectively equivalent to having all or part of base station functions (e.g., a gNB) on board the satellite (or UAS platform).

In one example, inter-satellite links (ISL) are optionally provided in case of a constellation of satellites. This may require regenerative payloads on board the satellites. ISL may operate in RF frequency or optical bands.

In one example, a UE is served by the satellite (or UAS platform) within the targeted service area.

In one example, a satellite (NTN payload) and satellite gateway (NTN gateway) can be referred as a gNB.

Although FIG. 4 illustrates an example 400 of NTN communication 400, various changes may be made to FIG. 4. For example, the number of satellites, gateways, etc. could be changed according to particular needs.

The next generation wireless communication system (e.g., 5G, beyond 5G, 6G) supports not only lower frequency bands but also higher frequency (mmWave) bands, e.g., 10 GHz to 100 GHz bands, so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters to service the end customer. A few example use cases the next generation wireless communication system wireless system is expected to address are enhanced Mobile Broadband (eMBB), massive Machine Type Communication (m-MTC), ultra-reliable low latency communication (URLL) etc. The eMBB requirements like tens of Gbps data rate, low latency, high mobility etc. address the market segment representing conventional wireless broadband subscribers needing internet connectivity everywhere, all the time and on the go. The m-MTC requirements like very high connection density, infrequent data transmission, very long battery life, low mobility address etc. address the market segment representing the Internet of Things (IoT)/Internet of Everything (IoE) envisioning connectivity of billions of devices. The URLL requirements like very low latency, very high reliability and variable mobility etc. address the market segment representing the Industrial automation application, and vehicle-to-vehicle/vehicle-to-infrastructure communication which is foreseen as one of the enablers for autonomous cars.

In the next generation wireless communication system (e.g., 5G, beyond 5G, 6G) operating in higher frequency (e.g., mmWave, terahertz) bands, a UE and gNB (or satellite or NTN payload) communicate with each other using beamforming. Beamforming techniques are used to mitigate propagation path losses and to increase the propagation distance for communication at higher frequency bands. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a transmit (TX) beam. A wireless communication system operating at high frequency uses a plurality of narrow TX beams to transmit signals in the cell as each narrow TX beam provides coverage to a part of the cell. The narrower the TX beam, the higher the antenna gain and hence the larger the propagation distance of the signal transmitted using beamforming. A receiver can also generate plurality of receive (RX) beam patterns of different directions. Each of these receive patterns can be also referred to as a receive (RX) beam.

In the next generation wireless communication system (e.g., 5G, beyond 5G, 6G) a UE can be in one of the following RRC states: RRC_IDLE, RRC_INACTIVE and RRC CONNECTED. Paging allows the network to reach UEs in the RRC_IDLE and in the RRC_INACTIVE state through Paging messages, and to notify UEs in the RRC_IDLE, RRC_INACTIVE and RRC_CONNECTED state of system information changes and ETWS (Earthquake and Tsunami Warning System)/CMAS (Commercial Mobile Alert System) indications through ShortMessages. Both Paging messages and Short Messages are addressed with P-RNTI on PDCCH, but while the former is sent on a PCCH logical channel (TB carrying paging message is transmitted over PDSCH (Physical downlink shared channel)), the latter is sent over PDCCH directly.

While in the RRC_IDLE state the UE monitors the paging channels for core network (CN)-initiated paging. While in the RRC_INACTIVE state the UE monitors paging channels for radio access network (RAN)-initiated paging and CN-initiated paging. A UE need not monitor paging channels continuously though. Paging discontinuous reception (DRX) is defined where the UE in an RRC_IDLE or RRC_INACTIVE state is only required to monitor paging channels during one Paging Occasion (PO) per DRX cycle.

A PO is a set of PDCCH monitoring occasions and can include multiple time slots (e.g., a subframe or OFDM symbol) where paging DCI (i.e., a PDCCH addressed to a P-RNTI) can be sent. One Paging Frame (PF) is one Radio Frame and may contain one or multiple PO(s) or a starting point of a PO. A PO associated with a PF may start in the PF or after the PF.

In multi-beam operations, the UE assumes that the same paging message and the same Short Message are repeated in all transmitted beams and thus the selection of the beam(s) for the reception of the paging message and Short Message is up to UE implementation. The paging message is the same for both RAN initiated paging and CN initiated paging. The UE initiates an RRC Connection Resume procedure upon receiving a RAN initiated paging. If the UE receives a CN initiated paging in the RRC_INACTIVE state, the UE moves to the RRC_IDLE state and informs the network access stratum (NAS).

The PF and PO for paging are determined (by the UE and base station e.g., gNB [or satellite or NTN payload]) by the following formulae:

System frame number (SFN) for the PF is determined by:

(SFN+PF_offset)mod T=(T div N)*(UE_ID mod N)

Index (is), indicating the index of the PO is determined by:

i_s=floor(UE_ID/N)mod Ns

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are the same as for remaining minimum system information (RMSI).

When SearchSpaceId=0 is configured for pagingSearchSpace, Ns is either 1 or 2. For Ns=1, there is only one PO which starts from the first PDCCH monitoring occasion for paging in the PF. For Ns=2, the PO is either in the first half frame (i_s=0) or the second half frame (is =1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionslnBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th value of the firstPDCCH-MonitoringOccasionOfPO parameter; otherwise, the starting PDCCH monitoring occasion number is equal to i_s*S*X. If X>1, when the UE detects a PDCCH transmission addressed to a P-RNTI within its PO, the UE is not required to monitor the subsequent PDCCH monitoring occasions for this PO.

The following parameters are used for the calculation of PF and i_s above: T: DRX cycle of the UE.
N: number of total paging frames in T; N is one of T, T/2, T/4, T/8, T/16
Ns: number of paging occasions for a PF; NS is one of 1, 2, 4
PF_offset: offset used for PF determination
UE_ID:
   If the UE operates in eDRX:
5G-S-TMSI mod 4096
   otherwise:
5G-S-TMSI mod 1024

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter firstPDCCH-MonitoringOccasionOfPO is signaled in SIB1 for paging in the bandwidth part (BWP) configured by initialDowninkBWP. For paging in a DL BWP other than the BWP configured by initialDowninkBWP, the parameter first-PDCCH-MonitoringOccasionOfPO is signaled in the corresponding BWP configuration. If the UE has no 5G-S-TMSI, for instance when the UE has not yet registered onto the network, the UE shall use as a default identity UE_ID=0 in the PF and is formulas above.

In order to reduce UE power consumption due to false paging alarms, the group of UEs monitoring the same PO can be further divided into multiple subgroups. With subgrouping, a UE shall monitor the PDCCH in its PO for paging if the subgroup to which the UE belongs is paged as indicated via an associated Paging Early Indication (PEI). If a UE cannot find its subgroup ID with the PEI configurations in a cell or if the UE is unable to monitor the associated PEI occasion corresponding to its PO, it shall monitor the paging in its PO.

Paging with CN assigned subgrouping is used in cells which support CN assigned subgrouping. A UE supporting CN assigned subgrouping in the RRC_IDLE or RRC_INACTIVE state can be assigned a subgroup ID (between 0 to 7) by an access and mobility function (AMF) through NAS signaling.

If the UE is not configured with a CN assigned subgroup ID, or if the UE configured with a CN assigned subgroup ID is in a cell supporting only UE_ID based subgrouping, the subgroup ID of the UE is determined by the formula below:

SubgroupID=(floor(UE_ID/(N*Ns))mod subgroupsNumForUEID)+(subgroupsNumPerPO−subgroupsNumForUEID),

where:
N: number of total paging frames in T, which is the DRX cycle of RRC_IDLE state
Ns: number of paging occasions for a PF
UE_ID: 5G-S-TMSI mod X, where X is 32768, if eDRX is applied; otherwise, X is 8192 subgroupsNumForUEID: number of subgroups for UE_ID based subgrouping in a PO, which is broadcasted in system information.

The UE monitors one PEI occasion per DRX cycle. A PEI occasion (PEI-O) is a set of PDCCH monitoring occasions (MOs) and can comprise multiple time slots (e.g., subframes or OFDM symbols) where PEI can be sent. In multi-beam operations, the UE assumes that the same PEI is repeated in all transmitted beams and thus the selection of the beam(s) for the reception of the PEI is up to UE implementation. The time location of PEI-O for a UE's PO is determined by a reference point and an offset:
The reference point is the start of a reference frame determined by a frame-level offset from the start of the first PF of the PF(s) associated with the PEI-O, provided by pei-FrameOffset in SIB1. The first PF of the PFs associated with the PEI-O is provided by (SFN for PF)−floor (i_{PO}/Ns)*T/N; where iₚₒ=((UE_IDmodN)·Nₛ+i_s)modN_{PO}^{PEI} is a paging occasion index, N_{PO}^{PEI}, is signaled by po-NumPerPEI.
The offset is a symbol-level offset from the reference point to the start of the first PDCCH monitoring occasion (MO) of this PEI-O, provided by firstPDCCH-MonitoringOccasionOfPEI-O in SIB1.

UEs periodically wake up once per DRX cycle, which dominates the power consumption in periods with no signaling or data traffic. Power consumption could be dramatically reduced by using a wake-up signal to trigger the main radio (MR) and a separate low power wakeup receiver (LR) which has the ability to monitor the wake-up signal with ultra-low power consumption. The low power wakeup receiver (LR) is expected to consume 1/100 of power consumed by the MR. The MR works for data transmission and reception, which can be turned off or set to deep sleep unless it is turned on. It is expected that a UE in the RRC_IDLE or RRC_INACTIVE state monitors the low power wakeup signal (LP WUS) using the LR if the UE and camped cell supports LP WUS. The gNB transmits the low power wakeup signal when the gNB needs to send RAN paging or CN paging to the UE or SI/emergency notifications to the UE. If the LP WUS is received,
Option 1: The UE monitors for a PEI in the UE's PEI-O. The UE monitors for the PEI (using the MR) and/or subsequently the UE monitors its PO in its PF (using the MR) and receives a paging message (if scheduled by the monitored PO) if the PEI indicates paging for the UE/UE specific paging subgroup. The UE determines its PEI-O, PF/PO as described earlier.
Option 2: The UE monitors its PO (e.g., if the cell/UE does not support PEI) in its PF. After PO monitoring, the UE receives a PDSCH (if scheduled by DCI in the monitored PO) including a paging message. The UE determines its PF/PO as in legacy.

The payload of LP WUS may include one or more of the following:
information on which user(s) is/are targeted by the LP-WUS:
   e.g., UE-group, -subgroup or -ID
cell information
SI change and ETWS/CMAS information
tracking area information, RAN area information

The next generation wireless communication system (e.g., 5G, beyond 5G, 6G), supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network (CN). The next generation wireless communication system also supports Multi-RAT Dual Connectivity (MR-DC) operation whereby a UE in the RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in the RRC_CONNECTED state not configured with CA/DC there is only one serving cell comprising the primary cell. For a UE in the RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the primary cell (PCell) and optionally one or more secondary cells (SCells). In NR the term Secondary Cell Group (SCG) refers to a group of serving cells associated with the Secondary Node, comprising of the PSCell and optionally one or more SCells. In NR PCell refers to a serving cell in a MCG, operating on the primary frequency, in which the UE either performs the initial connection establishment procedure or initiates the connection re-establishment procedure. In NR for a UE configured with CA, an Scell is a cell providing additional radio resources on top of the Special Cell. Primary SCG Cell (PSCell) refers to a serving cell in a SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

In the next generation wireless communication system (e.g., 5G, beyond 5G, 6G), a node B (gNB) or base station in cell broadcast Synchronization Signal and PBCH block (SSB) includes primary and secondary synchronization signals (PSS, SSS) and system information. System information includes common parameters needed to communicate in cell. In the fifth generation wireless communication system (also referred to as next generation radio or NR), System Information (SI) is divided into the MIB and a number of SIBs where: The MIB is always transmitted on the BCH with a periodicity of 80 ms and repetitions made within 80 ms and it includes parameters that are needed to acquire SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to an SI message, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which includes one or several cells and is identified by systemInformationAreaID; The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in the RRC_CONNECTED state, the network can provide system information through dedicated signaling using the RRCReconfiguration message, e.g., if the UE has an active BWP with no common search space configured to monitor system information, paging, or upon request from the UE. In the RRC_CONNECTED state, the UE acquires the required SIB(s) only from the PCell. For a PSCell and SCells, the network provides the required SI by dedicated signaling, i.e., within an RRCReconfiguration message. Nevertheless, the UE acquires the MIB of the PSCell to get SFN timing of the SCG (which may be different from the MCG). Upon change of relevant SI for the SCell, the network releases and adds the concerned SCell. For a PSCell, the SI is changed with Reconfiguration with Sync.

In the next generation wireless communication system (e.g., 5G, beyond 5G, 6G), a Physical Downlink Control Channel (PDCCH) is used to schedule DL transmissions on the physical downlink shared channel (PDSCH) and UL transmissions on the physical uplink shared channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In the next generation wireless communication system (e.g., 5G, beyond 5G, 6G), a list of search space configurations is signaled by the gNB for each configured BWP of the serving cell wherein each search configuration is uniquely identified by a search space identifier. The search space identifier is unique amongst the BWPs of a serving cell. An identifier of the search space configuration to be used for a specific purpose such as paging reception, SI reception, and random access response reception is explicitly signaled by the gNB for each configured BWP. In NR search space configuration comprises the parameters Monitoring-periodicity-PDCCH-slot, Monitoring-offset-PDCCH-slot, Monitoring-symbols-PDCCH-within-slot and duration. A UE determines the PDCCH monitoring occasion(s) within a slot using the parameters PDCCH monitoring periodicity (Monitoring-periodicity-PDCCH-slot), PDCCH monitoring offset (Monitoring-offset-PDCCH-slot), and PDCCH monitoring pattern (Monitoring-symbols-PDCCH-within-slot). PDCCH monitoring occasions are in the slots ‘x’ to x+duration where the slot with number ‘x’ in a radio frame with number ‘y’ satisfies the equation below:

$$( y * ( number of slots in a radio frame ) + x - Monitoring - offset - PDCCH - slot ) mod ( Monitoring - periodicity - PDCCH - slot ) = 0 ;$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the corset associated with the search space. The search space configuration includes the identifier of the CORESET configuration associated with it. A list of CORESET configurations are signaled by the gNB for each configured BWP of the serving cell wherein each CORESET configuration is uniquely identified by a CORESET identifier. The CORESET identifier is unique amongst the BWPs of a serving cell. Note that each radio frame is of 10 ms duration. The radio frame is identified by a radio frame number or system frame number. Each radio frame comprises several slots wherein the number of slots in a radio frame and duration of slots depends on sub carrier spacing. The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in the TCI state list is activated and indicated to the UE by the gNB. The TCI state indicates the DL TX beam (DL TX beam is QCLed with SSB/CSI RS of TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor the PDCCH on the one active BWP i.e., it does not have to monitor the PDCCH on the entire DL frequency of the serving cell. In the RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signaling, or by the MAC entity itself upon initiation of a random access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either an RRC or PDCCH. For unpaired spectrum, a DL BWP is paired with a UL BWP, and BWP switching is common for both UL and DL. Upon expiry of the BWP inactivity timer the UE switches from the active DL BWP to the default DL BWP or initial DL BWP (if a default DL BWP is not configured).

In the next generation wireless communication system (e.g., 5G, beyond 5G, 6G), random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UEs in the RRC CONNECTED state. Several types of random access procedures are supported.

In Contention based random access (CBRA), also referred to as 4 step CBRA, the UE first transmits a Random Access preamble (also referred as a Msg1) and then waits for a Random access response (RAR) in the RAR window. The RAR is also referred to as a Msg2. A next generation node B (gNB) transmits the RAR on the physical downlink shared channel (PDSCH). A PDCCH scheduling the PDSCH carrying the RAR is addressed to a RA-radio network temporary identifier (RA-RNTI). The RA-RNTI identifies the time-frequency resource (also referred to as a physical RA channel (PRACH) occasion or PRACH transmission (TX) occasion or RA channel (RACH) occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for normal UL (NUL) carrier and 1 for supplementary UL (SUL) carrier. Several RARs for various Random-access preambles detected by the gNB can be multiplexed in the same RAR media access control (MAC) protocol data unit (PDU) by the gNB. A RAR in a MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in a RACH configuration) number of times, the UE goes back to the first step i.e., the LIE selects a random access resource (preamble/RACH occasion) and transmits the RA preamble. A backoff may be applied before going back to the first step.

If the RAR corresponding to its RA preamble transmission is received the IE transmits a message 3 (Msg3) in the UL grant received in the RAR. The Msg3 includes a message such as an RRC connection request, RRC connection re-establishment request, RRC handover confirm, scheduling request, SI request etc. The Msg3 may include the IE identity (i.e., cell-radio network temporary identifier (C-RNTI) or system architecture evolution (SAE)-temporary mobile subscriber identity (S-TMSI) or a random number). After transmitting the Msg3, The UE starts a contention resolution timer. While the contention resolution timer is running, if the LIE receives a physical downlink control channel (PDCCH) addressed to the C-RNTI included in the Msg3, contention resolution is considered successful, the contention resolution timer is stopped, and the RA procedure is completed. While the contention resolution timer is running, if the LIE receives a contention resolution MAC control element (CE) including the UE's contention resolution identity (first X bits of common control channel [CCCH] service data unit [SDU]transmitted in the Msg3), the contention resolution is considered successful, the contention resolution timer is stopped, and the RA procedure is completed. If the contention resolution timer expires and the LIE has not yet transmitted the RA preamble for a configurable number of times, the UE goes back to the first step i.e., the UE selects a random access resource (preamble/RACH occasion) and transmits the RA preamble. A backoff may be applied before going back to first step.

Contention free random access (CFRA), also referred to as legacy CFRA or 4 step CFRA, is used for scenarios such as handover where low latency is required, timing advance establishment for a secondary cell (Scell), etc. An Evolved node B (eNB) assigns to the UE a dedicated Random access preamble. The UE transmits the dedicated RA preamble. The eNB transmits the RAR on a PDSCH addressed to an RA-RNTI. The RAR conveys the RA preamble identifier and timing alignment information. The RAR may also include a UL grant. The RAR is transmitted in a RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if the PDCCH addressed to the C-RNTI is received in search space for beam failure recovery. If the RAR window expires and the RA is not successfully completed and UE has not yet transmitted the RA preamble for a configurable (configured by the gNB in a RACH configuration) number of times, the UE retransmits the RA preamble.

For certain events such has handover and beam failure recovery if dedicated preamble(s) are assigned to the UE, during the first step of random access i.e., during random access resource selection for Msg1 transmission, the UE determines whether to transmit a dedicated preamble or non dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e., dedicated preambles/ROs) are provided by the gNB, the UE selects a non dedicated preamble. Otherwise the UE selects dedicated preamble. During the RA procedure, one random access attempt can be CFRA while other random access attempt can be CBRA.

In the first step of 2 step contention based random access (2 step CBRA), the UE transmits a random access preamble on a PRACH and a payload (i.e., MAC PDU) on the PUSCH. The random access preamble and payload transmission is also referred as MsgA. In the second step, after MsgA transmission, the UE monitors for a response from the network (i.e., gNB) within a configured window. The response is also referred as a MsgB. The next generation node B (gNB) transmits the MsgB on the physical downlink shared channel (PDSCH). A PDCCH scheduling the PDSCH carrying the MsgB is addressed to a MsgB-radio network temporary identifier (MSGB-RNTI). The MSGB-RNTI identifies the time-frequency resource (also referred to as a physical RA channel (PRACH) occasion or PRACH transmission (TX) occasion or RA channel (RACH) occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for the Msg1 transmission (0 for normal UL (NUL) carrier and 1 for supplementary UL (SUL) carrier.

If a CCCH SDU was transmitted in the MsgA payload, the UE performs contention resolution using the contention resolution information in the MsgB. The contention resolution is successful if the contention resolution identity received in the MsgB matches first 48 bits of the CCCH SDU transmitted in the MsgA. If a C-RNTI was transmitted in the MsgA payload, the contention resolution is successful if the UE receives a PDCCH addressed to the C-RNTI. If the contention resolution is successful, the random access procedure is considered successfully completed. Instead of contention resolution information corresponding to the transmitted MsgA, MsgB may include a fallback information corresponding to the random access preamble transmitted in the MsgA. If the fallback information is received, the UE transmits a Msg3 and performs contention resolution using a Msg4 as in CBRA procedure. If the contention resolution is successful, the random access procedure is considered successfully completed. If the contention resolution fails upon fallback (i.e., upon transmitting a Msg3), the UE retransmits MsgA. If the configured window in which the UE monitors the network response after transmitting the MsgA expires and the UE has not received a MsgB including contention resolution information or fallback information as explained above, the UE retransmits the MsgA. If the random access procedure is not successfully completed even after transmitting the msgA a configurable number of times, the UE falls back to 4 step RACH procedure i.e., the UE only transmits the PRACH preamble.

The MsgA payload may include one or more of a common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include a UE ID (e.g., random ID, S-TMSI, C-RNTI, resume ID, etc.) along with the preamble in first step. The UE ID may be included in the MAC PDU of the MsgA. A UE ID such as C-RNTI may be carried in the MAC CE wherein the MAC CE is included in the MAC PDU. Other UE IDs (such as random ID, S-TMSI, C-RNTI, resume ID, etc.) may be carried in a CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before it is attached to the network), then the UE ID is the random ID. When the UE performs RA in the IDLE state after the UE is attached to the network, the UE ID is S-TMSI. If the UE has an assigned C-RNTI (e.g., in the connected state), the UE ID is C-RNTI. In case the UE is in the INACTIVE state, the UE ID is resume ID. In addition to a UE ID, some addition control information can be sent in the MsgA. The control information may be included in the MAC PDU of the MsgA. The control information may include one or more of a connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

In the case of 2 step contention free random access (2 step CFRA), the gNB assigns to the UE dedicated Random access preamble(s) and PUSCH resource(s) for the MsgA transmission. RO(s) to be used for preamble transmission may also be indicated. In the first step, the UE transmits a random access preamble on a PRACH and a payload on a PUSCH using the contention free random access resources (i.e., dedicated preamble/PUSCH resource/RO). In the second step, after the MsgA transmission, the UE monitors for a response from the network (i.e., gNB) within a configured window. The response is also referred to as a MsgB.

The next generation node B (gNB) transmits the MsgB on the physical downlink shared channel (PDSCH). The PDCCH scheduling the PDSCH carrying the MsgB is addressed to a MsgB-radio network temporary identifier (MSGB-RNTI). The MSGB-RNTI identifies the time-frequency resource (also referred as a physical RA channel (PRACH) occasion or PRACH transmission (TX) occasion or RA channel (RACH) occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where the UE has transmitted the Msg1, i.e., RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If the UE receives a PDCCH addressed to the C-RNTI, the random access procedure is considered successfully completed. If the UE receives fallback information corresponding to its transmitted preamble, the random access procedure is considered successfully completed.

In the RRC_CONNECTED state, the UE performs measurements of serving cell(s) and neighbor cell(s). The UE may need a measurement gap to perform measurements depending on the capability of the UE, the active BWP of the UE and the current operating frequency.

For SSB based inter-frequency measurement, if the measurement gap requirement information is reported by the UE, a measurement gap configuration may be provided according to the information. Otherwise, a measurement gap configuration is always provided in the following cases:
If the UE only supports per-UE measurement gaps;
If the UE supports per-FR measurement gaps and any of the serving cells are in the same frequency range of the measurement object.

For SSB based intra-frequency measurement, if the measurement gap requirement information is reported by the UE, a measurement gap configuration may be provided according to the information. Otherwise, a measurement gap configuration is always provided in the following case:
Other than the initial BWP, if any of the UEs or RedCap UEs configured BWPs do not contain the frequency domain resources of the SSB associated to the initial DL BWP, and for a RedCap UE, are not configured with NCD-SSB for serving cell measurement.

During an activated measurement gap, UEs on the Serving Cell(s) in the corresponding frequency range of the measurement gap configured: not perform the transmission of HARQ feedback, SR, and CSI; not report SRS; not transmit on UL-SCH except for Msg3 or the MSGA payload; and if the ra-ResponseWindow or the ra-ContentionResolutionTimer or the msgB-ResponseWindow is running: monitor the PDCCH. Otherwise, the UEs not monitor the PDCCH and not receive on DL-SCH.

In communication satellites with many beams the satellite power must be shared between beams. This results in lower EIRP density per beam and reduced DL coverage. This reduction severely impacts the ability for UEs in coverage of such satellites to receive DL signaling such as paging. The present disclosure provides methods to enhance coverage for paging transmission.

Scheduling restrictions are applied for performing radio resource management (RRM) measurements. Scheduling restrictions apply, on SSBs to be measured, starting from one symbol before and ending one symbol after each SSB. In practice this means that every slot where SSBs are to be measured is restricted from scheduling. This can result in a UE not being available for scheduling by the network in nearly 25% of the time if, e.g., 64 SSBs are to be measured and assuming SS/PBCH Block Measurement Timing Configuration (SMTC) windows of 5 ms occurring every 20 ms. This may result in capacity loss ranging from about 5% to more than 50%, depending on the packet delay budget (PDB) and SMTC configuration.

Time sensitive eXtended Reality (XR) XR service traffic can be delayed due to measurement gap (MG). eXtended Reality (XR) is a term for different types of realities and refers to all real-and-virtual combined environments and human-machine interactions generated by computer technology and wearables. It includes the following representative forms and the areas interpolated among them: Augmented Reality (AR); Mixed Reality (MR); and Virtual Reality (VR). Many of the XR use cases are characterized by quasi-periodic traffic (with possible jitter) with a high data rate in DL (i.e., video streams) combined with the frequent UL (i.e., pose/control updates) and/or UL video streams. Both DL and UL traffic are also characterized by relatively strict packet delay budget (PDB). The present application discloses solutions to better support such challenging services.

As previously described herein, reduced DL coverage in an NTN severely impacts the ability for UEs in the coverage of satellites to receive DL signaling such as paging. The present disclosure provides a notification/alert channel for NTNs to address the coverage issue. The notification/alert channel is designed to have better coverage than the PDCCH/PDSCH used for paging. A notification/alert can be sent to the UE on this channel before paging the UE. Upon receiving the notification/alert for paging, the UE can inform its user to move into a good coverage area. For example, the user can take the phone outside of a briefcase or move outdoors upon receiving the notification/alert.

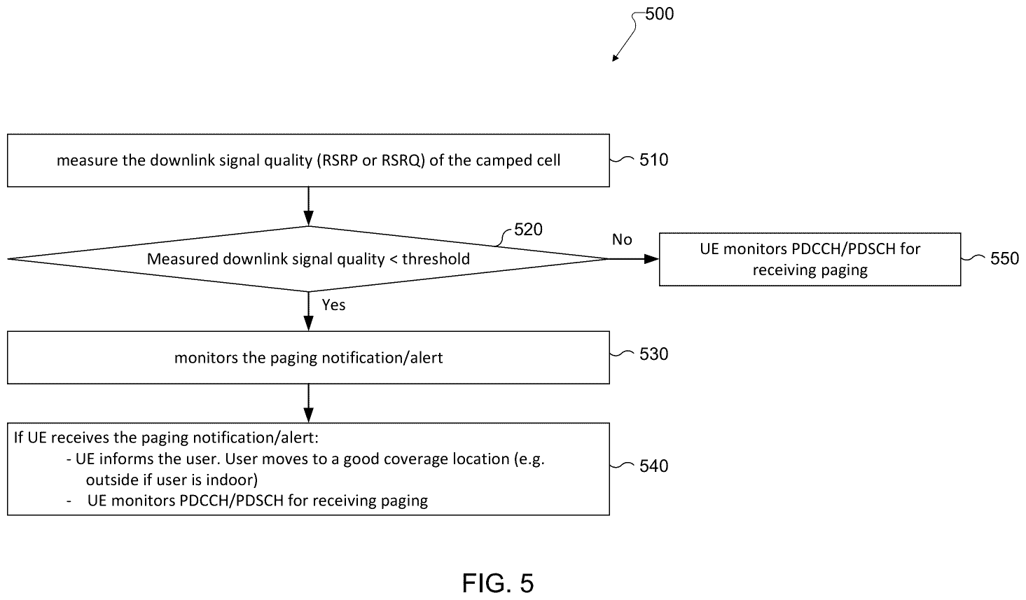

FIG. 5 illustrates an example method for paging transmission and reception 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for paging transmission and reception could be used without departing from the scope of this disclosure.

In the example of FIG. 5, a UE, such as UE 116 of FIG. 1 is camped in a Cell. At step 510, the UE measures the downlink signal quality (RSRP or RSRQ) in the cell. The downlink signal quality of cell can be measured by measuring the SSB(s) or other RS(s) transmitted in DL by network (i.e., gNB or satellite of the camped cell).

In one embodiment, at step 520, if the measured downlink signal quality is less than a threshold (or less than or equal to a threshold), the method proceeds to step 530. Otherwise, the method proceeds to step 550. In one embodiment, the threshold can be signaled by the network (i.e., the gNB or satellite of the camped cell) in system information (e.g., an SI message or SIB). The threshold can be common for all UEs in the cell. In another embodiment, the threshold can be pre-defined. In another embodiment, the threshold can be signaled by the network (i.e., the gNB or satellite of the camped cell) in an RRC message.

In another embodiment, step 520, if the measured downlink signal quality is less than a threshold (or less than or equal to a threshold) and paging notification/alert is supported by the UE and the camped cell (the camped cell can indicate support for paging notification/alert by signaling an indication or configuration for paging notification/alert in system information or an RRC message) the method proceeds to step 530. Otherwise, the method proceeds to step 550. In one embodiment, the threshold can be signaled by the network (i.e., the gNB or satellite of the camped cell) in system information (e.g., an SI message or SIB). The threshold can be common for all UEs in the cell. In another embodiment, the threshold can be pre-defined. In another embodiment, the threshold can be signaled by the network (i.e., the gNB or satellite of the camped cell) in an RRC message.

At step 530, the UE monitors the paging notification/alert (or paging notification/alert channel or paging notification/alert occasion(s)). At step 540, if the UE receives the paging notification/alert (or paging notification/alert including UE identity or paging notification/alert including identity of UE's subgroup) the UE informs the user of the UE. For example, the UE may sound a notification or display a message indicating receipt of the paging notification/alert. After receiving the alert, the user moves to a good coverage location (e.g., outside if the user is indoors). The UE then monitors the PDCCH/PDSCH (or PO or PEI-O or LPWUS) for receiving paging.

In one embodiment, at step 550, if the measured downlink signal quality is not less than a threshold (or not less than equal to threshold), the UE monitors the PDCCH/PDSCH (or PO or PEI-O or LPWUS) for receiving paging. In another embodiment, at step 550, if paging notification/alert is not supported by the UE and/or not supported by the camped cell, the UE monitors the PDCCH/PDSCH (or PO or PEI-O or LPWUS) for receiving paging.

Although FIG. 5 illustrates one example method for paging transmission and reception 500, various changes may be made to FIG. 5. For example, while shown as a series of steps, various steps in FIG. 5 could overlap, occur in parallel, occur in a different order, occur any number of times, be omitted, or replaced by other steps.

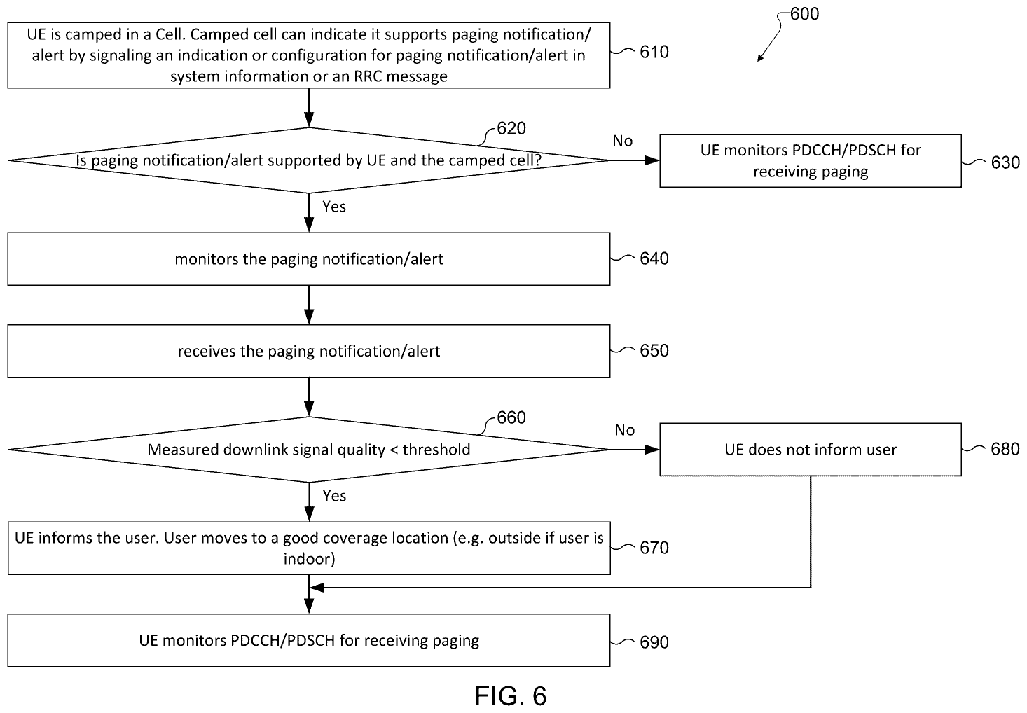

FIG. 6 illustrates another example method for paging transmission and reception 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for paging transmission and reception could be used without departing from the scope of this disclosure.

In the example of FIG. 6, a UE, such as UE 116 of FIG. 1 is camped in a Cell. At step 610, the camped cell can indicate that the cell supports paging notification/alert by signaling an indication or configuration for paging notification/alert in system information or an RRC message. At step 620, if paging notification/alert is supported by the UE and the camped cell, the method proceeds to step 640. Otherwise, the method proceeds to step 630.

At step 630, (i.e., if paging notification/alert is not supported by the UE or if paging notification/alert is not supported the camped cell), the UE monitors the PDCCH/PDSCH (or PO or PEI-O or LPWUS) for receiving paging.

At step 640, the UE monitors for the paging notification/alert (or paging notification/alert channel or paging notification/alert occasion(s)).

At step 650, the UE receives the paging notification/alert (or paging notification/alert including the UE's identity or paging notification/alert including the identity of the UE's subgroup). At step 660, if the measured downlink signal quality is less than a threshold (or less than or equal to a threshold), the method proceeds to step 670. Otherwise, the method proceeds to step 680.

At step 670, the UE informs the user of the UE that the signal quality is less than the threshold (or less than or equal to the threshold). For example, the UE may sound a notification or display a message indicating poor signal quality. After receiving the alert, the user relocates to a good cell coverage location (e.g., outside if the user is indoors).

At step 680, the UE does not inform the user of the measured downlink signal quality, and the method proceeds to step 690.

At step 690, the UE monitors the PDCCH/PDSCH (or PO or PEI-O or LPWUS) for receiving paging.

Although FIG. 6 illustrates one example method for paging transmission and reception 600, various changes may be made to FIG. 6. For example, while shown as a series of steps, various steps in FIG. 6 could overlap, occur in parallel, occur in a different order, occur any number of times, be omitted, or replaced by other steps.

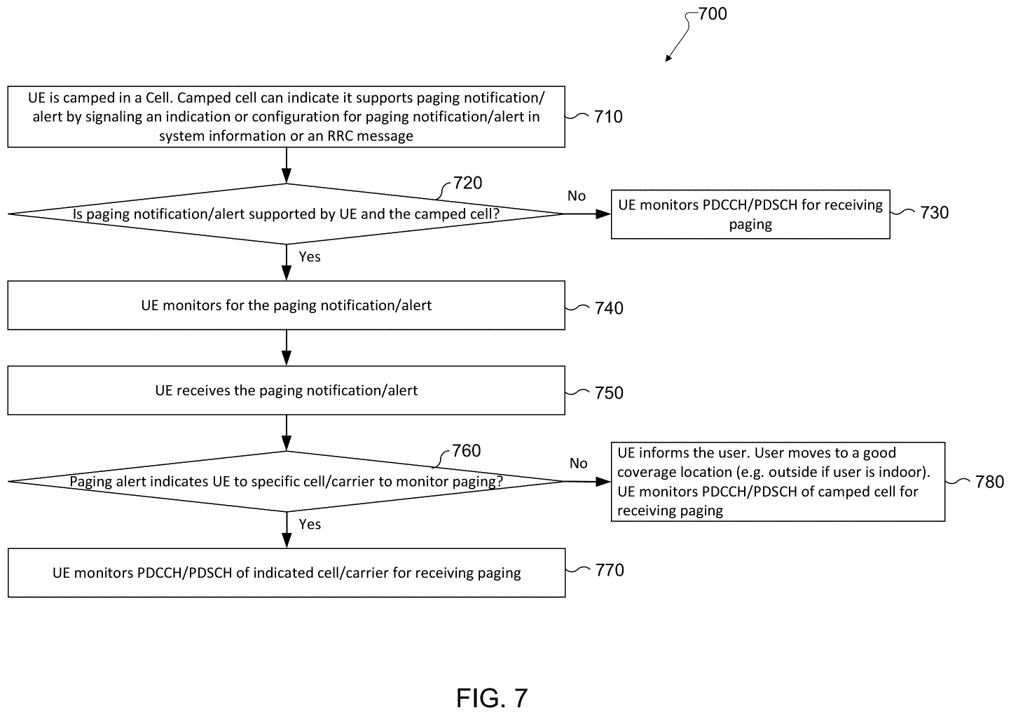

FIG. 7 illustrates another example method for paging transmission and reception 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for paging transmission and reception could be used without departing from the scope of this disclosure.

In the example of FIG. 7, a UE, such as UE 116 of FIG. 1 is camped in a Cell. At step 710, the camped cell can indicate that the cell supports paging notification/alert by signaling an indication or configuration for paging notification/alert in system information or an RRC message. In some embodiments, at step 710 the UE measures the downlink signal quality (RSRP or RSRQ) in the cell. The downlink signal quality of the cell can be measured by measuring the SSB(s) or other RS(s) transmitted in DL by the network (i.e., a gNB or satellite of the camped cell).

In one embodiment, at step 720, if paging notification/alert is supported by the UE and the camped cell, the method proceeds to step 740. Otherwise, the method proceeds to step 730.

In another embodiment, at step 720, if the measured downlink signal quality is less than a threshold (or less than equal to a threshold) and paging notification/alert is supported by UE and the camped cell, the method proceeds to step 740. Otherwise, the method proceeds to step 730.

At step 730, (i.e., if paging notification/alert is not supported by the UE or if paging notification/alert is not supported the camped cell), the UE monitors the PDCCH/PDSCH (or PO or PEI-O or LPWUS) for receiving paging.

At step 740, the UE monitors for the paging notification/alert (or paging notification/alert channel or paging notification/alert occasion(s)).

At step 750, the UE receives the paging notification/alert (or paging notification/alert including the UE's identity or paging notification/alert including the identity of the UE's subgroup). The paging notification/alert (or paging notification/alert including the UE's identity or paging notification/alert including the identity of the UE's subgroup) may indicate a specific cell or carrier for the UE to monitor for paging. At step 760, if the paging alert indicates a specific cell/carrier for the UE to monitor for paging, the method proceeds to step 770. Otherwise, the method proceeds to step 780.

At step 770, the UE monitors the PDCCH/PDSCH (or PO or PEI-O or LPWUS) of the indicated cell/carrier for receiving paging.

At step 780, the UE informs the user of the UE that the paging notification/alert was received. For example, the UE may sound a notification or display a message indicating receipt of the paging notification/alert. After receiving the alert, the user relocates to a good cell coverage location (e.g., outside if the user is indoors). The UE then monitors the PDCCH/PDSCH (or PO or PEI-O or LPWUS) of the camped cell for receiving paging.

Although FIG. 7 illustrates one example method for paging transmission and reception 700, various changes may be made to FIG. 7. For example, while shown as a series of steps, various steps in FIG. 7 could overlap, occur in parallel, occur in a different order, occur any number of times, be omitted, or replaced by other steps.

In one embodiment, the PF and PO for paging are determined (by the UE and base station e.g., gNB [or satellite or NTN payload]) by the following formulae:

The SFN for the PF is determined by:

(SFN+PF_offset)mod T=(T div N)*(UE_ID mod N)

Index (is), indicating the index of the PO is determined by:

i_s=floor(UE_ID/N)mod Ns

The PDCCH monitoring occasions for paging are determined according to pagingSearchSpace and firstPDCCH-MonitoringOccasionOfPO and nrofPDCCH-MonitoringOccasionPerSSB-InPO (or nrofRepetitionsPerSSB-InPO) if configured. When SearchSpaceId=0 is configured for pagingSearchSpace, the PDCCH monitoring occasions for paging are the same as for RMSI.

When SearchSpaceId=0 is configured for pagingSearchSpace, Ns is either 1 or 2. For Ns=1, there is only one PO which starts from the first PDCCH monitoring occasion for paging in the PF. For Ns=2, the PO is either in the first half frame (i_s=0) or the second half frame (is =1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionslnBurst in SIB1 and X is the nrofPDCCH-MonitoringOccasionPerSSB-InPO (or nrofRepetitionsPerSSB-InPO) if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (is +1)^{th} PO is the (i_s+1)^{th} value of the firstPDCCH-MonitoringOccasionOfPO parameter; otherwise, it is equal to i_s*S*X.

In one embodiment, if X>1, there are ‘X’ PDCCH monitoring occasions per SSB and the network transmits Paging DCI in each PDCCH monitoring occasion of the SSB in the PO. If X>1, the UE receives paging DCI in one or more or all of X PDCCH monitoring occasions of the SSB in the PO and combines them to decode the DCI. After the paging DCI is successfully decoded, the UE may stop monitoring other PDCCH monitoring occasions of the SSB in the PO.

In another embodiment, if X>1 and the cell is a licensed cell: there are ‘X’ PDCCH monitoring occasions per SSB; the network transmits Paging DCI in each PDCCH monitoring occasion of the SSB in the PO; the UE receives paging DCI in one or more or all of X PDCCH monitoring occasions of the SSB in the PO and combines them to decode the DCI; and after the paging DCI is successfully decoded, the UE may stop monitoring other PDCCH monitoring occasions of SSB in PO. If X>1 and the cell is an unlicensed cell: there are ‘X’ PDCCH monitoring occasions per SSB; the network transmits Paging DCI in a PDCCH monitoring occasion of the SSB in the PO for which LBT is successful; and when the UE detects a PDCCH transmission addressed to a P-RNTI within its PO, the UE is not required to monitor the subsequent PDCCH monitoring occasions for this PO.

In another embodiment, if X>1 and paging repetition (or paging repetition set to TRUE) is indicated/signaled by the network in a paging configuration/system information/RRC message: there are ‘X’ PDCCH monitoring occasions per SSB; the network transmits Paging DCI in each PDCCH monitoring occasion of the SSB in the PO; the UE receives paging DCI in one or more or all of X PDCCH monitoring occasions of the SSB in the PO and combines them to decode the DCI; and after the paging DCI is successfully decoded, the UE may stop monitoring other PDCCH monitoring occasions of the SSB in the PO. If X>1 and paging repetition is not indicated/signaled by the network in a paging configuration/system information/RRC message (e.g. paging repetition is set to FALSE or not signaled): there are ‘X’ PDCCH monitoring occasions per SSB; the network transmits Paging DCI in a PDCCH monitoring occasion of the SSB in the PO for which LBT is successful; and when the UE detects a PDCCH transmission addressed to a P-RNTI within its PO, the UE is not required to monitor the subsequent PDCCH monitoring occasions for this PO.

In another embodiment, a PO is a set of ‘S*X*Y’ consecutive PDCCH monitoring occasions where ‘S’ is the number of actual transmitted SSBs determined according to ssb-PositionsInBurst in SIB1 and X is the number of PDCCH monitoring occasions per SSB in the PO which are repeated Y times, X, Y is equal to 1 if not configured. The [x*S+K]^{th} PDCCH monitoring occasion for paging in the PO corresponds to the K^{th} transmitted SSB, where x=0, 1, . . . , X*Y−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. WhenfirstPDCCH-MonitoringOccasionOfPO is present, the starting PDCCH monitoring occasion number of (is +1)th PO is the (i_s+1)^{th} value of the firstPDCCH-MonitoringOccasionOfPO parameter; otherwise, it is equal to is*S*X*Y. In each set of ‘X’ PDCCH monitoring occasions, Paging DCI is transmitted at most once. Note that there are ‘Y’ such sets, so the paging DCI will be transmitted Y times in the PO. The UE can receive one or more or all of these ‘Y’ paging DCI and combine them to decode the DCI.

The following parameters are used for the calculation of PF and i_s above:
T: DRX cycle of the UE.
N: number of total paging frames in T; N is one of T, T/2, T/4, T/8, T/16
Ns: number of paging occasions for a PF; NS is one of 1, 2, 4
PF_offset: offset used for PF determination
UE_ID:
   if the UE operates in eDRX:
      5G-S-TMSI mod 4096
   otherwise:
      5G-S-TMSI mod 1024

Parameters Ns, nAndPagingFrameOffset, nrofPDCCH-MonitoringOccasionPerSSB-InPO (or nrofRepetitionsPerSSB-InPO), and the length of the default DRX Cycle are signaled in SIB1. The values of N and PF_offset are derived from the parameter nAndPagingFrameOffset. The parameter firstPDCCH-MonitoringOccasionOfPO is signaled in SIB1 for paging in the BWP configured by initialDowninkBWP. For paging in a DL BWP other than the BWP configured by initialDowninkBWP, the parameter first-PDCCH-MonitoringOccasionOfPO is signaled in the corresponding BWP configuration. If the UE has no 5G-S-TMSI, for instance when the UE has not yet registered onto the network, the UE shall use as a default identity UE_ID=0 in the PF and i_s formulas above.

In one embodiment, the UE may monitor for a PEI before the determined PO.

A PEI occasion is a set of ‘S*X’ consecutive PDCCH MOs, where ‘S’ is the number of actual transmitted SSBs determined according to ssb-PositionslnBurst in SIB1, and X is the nrofPDCCH-MonitoringOccasionPerSSB-InPO (or nrofRepetitionsPerSSB-InPO), if configured, or is equal to 1 otherwise. The [x*S+K]^{th} PDCCH MO for the PEI in the PEI-O corresponds to the K^{th} transmitted SSB, where x=0, 1, . . . , X−1, K=1, 2, . . . , S. The PDCCH MOs for the PEI which do not overlap with UL symbols (determined according to tdd-UL-DL-ConfigurationCommon) are sequentially numbered from zero starting from the first PDCCH MO for the PEI in the PEI-O.

In one embodiment, if X>1, there are ‘X’ PDCCH monitoring occasions per SSB and the network transmits a PEI DCI in each PDCCH monitoring occasion of the SSB in the PEI-O. If X>1, the UE receives the PEI DCI in one or more or all of X PDCCH monitoring occasions of the SSB in the PEI-O and combines them to decode the DCI. After the PEI DCI is successfully decoded, the UE may stop monitoring other PDCCH monitoring occasions of SSB in PEI-O.

In another embodiment, if X>1 and cell is licensed cell: there are ‘X’ PDCCH monitoring occasions per SSB; the network transmits PEI DCI in each PDCCH monitoring occasion of the SSB in the PEI-O; the UE receives the PEI DCI in one or more or all of X PDCCH monitoring occasions of the SSB in the PEI-O and combines them to decode the DCI; and after the PEI DCI is successfully decoded, the UE may stop monitoring other PDCCH monitoring occasions of SSB in PEI-O. If X>1 and cell is unlicensed cell: there are ‘X’ PDCCH monitoring occasions per SSB; the network transmits a PEI DCI in a PDCCH monitoring occasion of the SSB in the PEI-O for which LBT is successful; and when the UE detects a PDCCH transmission addressed to a P-RNTI within its PEI-O, the UE is not required to monitor the subsequent PDCCH monitoring occasions for this PEI-O.

In another embodiment, if X>1 and paging repetition (or paging repetition set to TRUE) is indicated/signaled by the network in a paging configuration/system information/RRC message: there are ‘X’ PDCCH monitoring occasions per SSB; the network transmits a PEI DCI in each PDCCH monitoring occasion of the SSB in the PEI-O; the UE receives the PEI DCI in one or more or all of X PDCCH monitoring occasions of the SSB in the PEI-O and combines them to decode the DCI; and after the PEI DCI is successfully decoded, the UE may stop monitoring other PDCCH monitoring occasions of the SSB in the PEI-O. If X>1 and paging repetition is not indicated/signaled by the network in a paging configuration/system information/RRC message (e.g. paging repetition is set to FALSE or not signaled): there are ‘X’ PDCCH monitoring occasions per SSB; the network transmits a PEI DCI in a PDCCH monitoring occasion of the SSB in the PEI-O for which LBT is successful; and when the UE detects a PDCCH transmission addressed to a P-RNTI within its PEI-O, the UE is not required to monitor the subsequent PDCCH monitoring occasions for this PEI-O.

In another embodiment, a PEI occasion is a set of ‘S*X*Y’ consecutive PDCCH MOs, where ‘S’ is the number of actual transmitted SSBs determined according to ssb-PositionslnBurst in SIB1, and X is the number of PDCCH monitoring occasions per SSB in a PEI-O which are repeated Y times, X Y is equal to 1 if not configured. The [x*S+K]^{th} PDCCH MO for the PEI in the PEI-O corresponds to the K^{th} transmitted SSB, where x=0, 1, . . . , X*Y−1, K=1, 2, . . . , S. The PDCCH MOs for the PEI which do not overlap with UL symbols (determined according to tdd-UL-DL-ConfigurationCommon) are sequentially numbered from zero starting from the first PDCCH MO for the PEI in the PEI-O. In each set of ‘X’ PDCCH monitoring occasions, a PEI DCI is transmitted at most once. Note that there are ‘Y’ such sets, so the PEI DCI will be transmitted Y times in the PEI-O. The UE can receive one or more or all of these ‘Y’ PEI DCIs and combine them to decode the DCI.

As previously described herein, time sensitive traffic can be delayed due to measurement gap (MG) in radio resource management (RRM) measurements. The present disclosure provides a relaxed UE operation during the measurement gap to better serve time sensitive traffic with a lowered delay.

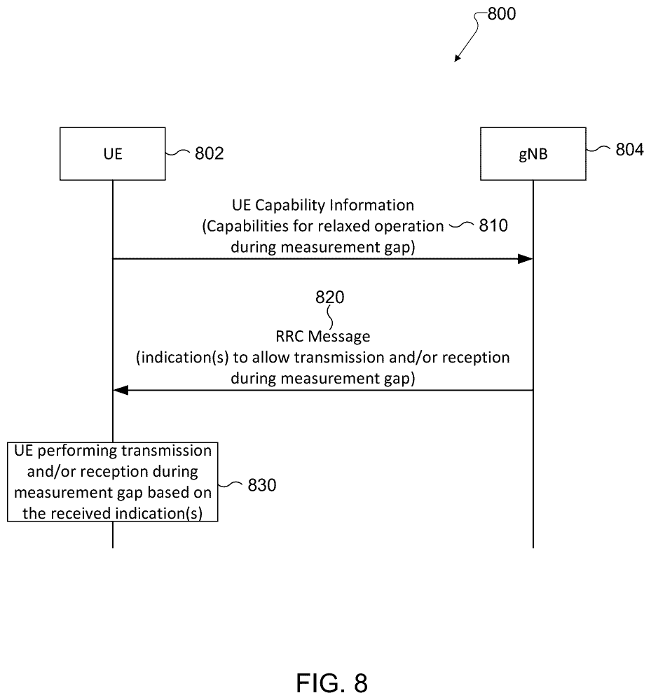

FIG. 8 illustrates an example of UE operation during a measurement gap 800 according to embodiments of the present disclosure. An embodiment of the operation illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of UE operation during a measurement gap could be used without departing from the scope of this disclosure.

In the example of FIG. 8, at step 810 a UE 802 indicates/signals to the network (e.g., gNB 804) of the UE's one or more capabilities for relaxed operation during a measurement gap. Relaxed operation can also be referred to as skipping a measurement gap (i.e., the UE performs transmissions/receptions which are otherwise not allowed during the measurement gap). Relaxed operation means that UE can perform at least one of the following operations during a measurement gap:
perform the transmission of HARQ feedback;
perform the transmission of SR;
perform the transmission of CSI;
report SRS;
transmit on UL-SCH;
transmit RACH;
monitor PDCCH even if the ra-ResponseWindow or the ra-ContentionResolutionTimer or the msgB-Response Window is not running or RACHless handover is not ongoing or RACHless layer1/layer2 triggered mobility based cell switch is not ongoing; and/or
receive on DL-SCH.

In one embodiment, there can be one capability indication which indicates whether the UE supports (or not) all of the above operations during measurement gap. In another embodiment, there can be one capability indication which indicates whether the UE supports a subset of the above operations during measurement gap. Which of the operations are included in the subset can be pre-defined. In another embodiment, there can be a separate capability indication for each of the above operations. In another embodiment, these operations can be grouped into several groups wherein the capability indication is separate for each group. For example, one group may include monitoring PDCCH and reception on PDSCH, another group may include transmit operations such as transmit on UL-SCH, transmit HARQ feedback, transmission of SR, CSI and report SRS. In another example one group may include monitoring PDCCH and reception on PDSCH, another group may include transmit operations such as transmit on UL-SCH, transmit HARQ feedback. In another example one group may include monitoring PDCCH and reception on PDSCH, another group may include transmit operations such as transmit on UL-SCH, transmit HARQ feedback; another group may include transmission of SR, CSI and report SRS. Note that several combinations are possible to associate operations into groups and all are not listed for brevity.

These one or more capabilities for relaxed operation can be defined/signalled/per UE, per duplex mode (FDD/TDD), per frequency range (e.g., FR1/FR2/FR2−1), per band, per band combinations, etc. as the UE may support different functionalities depending on those parameters. One or more of these capabilities may be indicated by UE 802 to the network (gNB 804) in the RRC_CONNNCTED state or during the connection setup or resume procedure. One or more of these capabilities may be indicated by UE 802 to the network (gNB 804) in an RRC message (e.g., UE assistance information message, UE capability information message or any other RRC message). One or more of these capabilities may be indicated by UE 802 to the Network (gNB 804) in a MAC CE. These capabilities may be indicated by UE 802 to the network (gNB 804) using a scheduling request (PUCCH), wherein scheduling request configuration for indicating this capability can be signaled by the network (gNB 804) to UE 802 (e.g., in an RRCReconfiguration message). In one embodiment, UE 802 may indicate one or more of these capabilities to the network (gNB 804) in response to a UE capability request from the network (gNB 804). In one embodiment, the UE may indicate one or more of these capabilities to the network (gNB 804) upon entering the RRC_CONNECTED state (from the RRC IDLE/RRC INACTIVE state). In one embodiment, UE 802 may indicate one or more of these capabilities to the network (gNB 804) upon handover/cell (PCell or PSCell) change/reconfiguration with sync procedure/cell switch based on layer1 layer 2 triggered mobility.

At step 820, Based on the received capabilitie(s) for relaxed operation during the measurement gap from UE 802, gNB 804 sends one or more indication(s) to allow transmission and/or reception during measurement gap(s). The indication can be common for all measurement gap configuration or can be per measurement gap configuration or can be for FR1 measurement gap(s) or can be for FR2 measurement gap(s) or can be for UE measurement gap(s). The gNB may indicate which transmission(s) such as UL-SCH/HARQ feedback/CSI/SR/SRS report/RACH and/or reception(s) such as DL-SCH/PDCCH, are allowed during measurement gap(s). One or more of transmission(s) such as UL-SCH/HARQ feedback/CSI/SR/SRS report/RACH and/or one or more of reception(s) such as DL-SCH/PDCCH, which are allowed during measurement gap can be pre-defined.

At step 830, UE 802 performs certain transmission(s) and/or reception (s) during measurement gap(s) based on the received indication(s). If the indication is for a certain measurement gap configuration, UE 802 performs certain transmission(s) and/or reception (s) during measurement gap(s) of that measurement gap configuration based on the received indication(s). If the indication is common for all measurement gap configurations, UE 802 performs certain transmission(s) and/or reception (s) during measurement gap(s) of all measurement gap configurations based on the received indication(s). If the indication is for a certain FR (e.g., FR1 or FR1), UE 802 performs certain transmission(s) and/or reception (s) during measurement gap(s) of measurement gap configuration(s) for that FR based on the received indication(s). If the indication is common for all per UE measurement gap configurations, UE 802 performs certain transmission(s) and/or reception(s) during per UE measurement gap(s) of all per UE measurement gap configurations based on the received indication(s).

Based on the measurement gap configuration, a measurement gap occurs periodically. In one embodiment, UE 802 performs certain transmission(s) and/or reception (s) during all measurement gaps of the measurement configuration based on the received indication(s). In one embodiment, UE 802 performs certain transmission(s) and/or reception (s) during selective (e.g., every odd or every even or alternate or gap occurring every X measurement gap period, where X is an integer>0) measurement gaps of the measurement configuration based on the received indication(s). These selective measurement gaps of the measurement configuration can be signalled by gNB 804 using RRC/MAC CE/DCI.

In one embodiment, UE 802 performs certain transmission(s) and/or reception (s) during measurement gap(s) based on the received indication(s) if transmission/reception during measurement gap is activated. In one embodiment, UE 802 performs certain transmission(s) and/or reception(s) during measurement gap(s) if transmission/reception during measurement gap is activated. Activation/deactivation of transmission/reception during measurement gap can be initiated using DCI or a MAC CE. The activation/deactivation can be common for all measurement gap configurations or can be per measurement gap configuration or can be for FR1 measurement gap(s) or can be for FR2 measurement gap(s) or can be for UE measurement gap(s). On one embodiment, once activated, transmission/reception during measurement gap is allowed until deactivated. In another embodiment, once activated, transmission/reception during measurement gap is allowed for a certain time duration. The time duration can be configured in a DCI, MAC CE, or RRC message.

In one embodiment, UE 802 indicates to the network (gNB 804) its capability to transmit in UL (or transmit UL SCH) during the measurement gap. This capability can also be referred to as enhanced measurement gap operation or measurement gap relaxation. This UE capability may be indicated by UE 802 to the network (gNB) in the RRC_CONNNCTED state or during the connection setup or connection resume procedure. This UE capability may be indicated by UE 802 to the network (gNB 804) in an RRC message (e.g., UE assistance information message, UE capability information message or any other RRC message). This UE capability may be indicated by UE 802 to the network (gNB 804) in a MAC CE. This UE capability may be indicated by UE 802 to the network (gNB 804) using a scheduling request (PUCCH), wherein a scheduling request configuration for indicating this capability can be signaled by the network (gNB 804) to UE 802 (e.g., in an RRCReconfiguration message). In one embodiment, UE 802 may indicate this capability to the network (gNB 804) in response to a UE capability request from the network (gNB 804). In one embodiment, UE 802 may indicate this capability to the network (gNB 804) upon entering the RRC_CONNECTED state (from the RRC IDLE/RRC INACTIVE state). In one embodiment, UE 802 may indicate this capability to the network (gNB 804) upon handover or cell switch.

In some embodiments, the network (gNB 804) indicates the LCG(s) or LCH(s) or RB(s) or DRB(s) or SRB(s) for which UE 802 is allowed to transmit in UL (or transmit UL SCH) during the measurement gap (MG) duration. Such an indication may be provided to UE(s) which support transmission during measurement gap.

In one embodiment, this indication can be per LCH. For example, gNB 804 can signal allowedTxIn-MeasurementGap-r19 ENUMERATED {True} in LogicalChannelConfig IE where LogicalChannelConfig IE provides the logical channel configuration LogicalChannelConfig à allowedTxIn-MeasurementGap-r19 ENUMERATED {True}. If this indication to transmit in UL (or transmit UL SCH) during the MG duration is received in a logical channel configuration:
In one embodiment, transmission for this LCH is allowed in measurement gaps of measurement gap configurations by default.
In one embodiment, a list of one or more measurement gap IDs of measurement gap configurations during which UE 802 is allowed to transmit for this LCH is signaled by gNB 804 to UE 802. Transmission for this LCH is allowed in the measurement gaps of the indicated measurement gap configuration (s).
In one embodiment, transmission of any data of this LCH is allowed during these measurement gaps.
In one embodiment, if UE 802 has pending data with remaining delivery time less than a threshold for this LCH, transmission for this LCH is allowed during these measurement gaps.
In one embodiment, if UE 802 has a total amount of data available for transmission in the buffer for this LCH greater than a threshold, transmission for this LCH is allowed during these measurement gaps. The threshold may be signaled by gNB 804 to UE 802.
In one embodiment, if UE 802 has pending data associated with certain QFI(s) in the buffer for this LCH, transmission for this LCH is allowed during these measurement gaps.
In one embodiment, if UE 802 has pending data (e.g., PDUs of a PDU set) associated with a PDU set delay budget less than a threshold in the buffer for this LCH, transmission for this LCH is allowed during these measurement gaps. The threshold may be signaled by gNB 804 to UE 802.
In one embodiment, if UE 802 has pending data (e.g., PDUs of a PDU set) associated with a certain PDU set importance (PSI) in the buffer for this LCH, transmission for this LCH is allowed during these measurement gaps. The certain PSIs may be signaled by gNB 804 to UE 802.
In one embodiment, if UE 802 has pending data (e.g., PDUs of a PDU set) associated with a PDU set importance (PSI) less than a threshold in the buffer for this LCH, transmission for this LCH is allowed during these measurement gaps. The threshold may be signaled by gNB 804 to UE 802.
In one embodiment, if UE 802 has pending data (e.g., PDUs of a PDU set) associated with a PDU set importance (PSI) greater than a threshold in the buffer for this LCH, transmission for this LCH is allowed during these measurement gaps. The threshold may be signaled by gNB 804 to UE 802.

In one embodiment, this indication can be per DRB. For example, gNB 804 can signal allowedTxIn-MeasurementGap-r19 ENUMERATED {True} in RLC-BearerConfig IE where RLC-BearerConfig IE provides the radio bearer configuration. If this indication to transmit in UL (or transmit UL SCH) during the MG duration is received in a radio bearer configuration:
In one embodiment, transmission for this radio bearer is allowed in all measurement gaps by default.
In one embodiment, a list of one or more measurement gap IDs of measurement gap configurations during which UE 802 is allowed to transmit for this radio bearer is signaled by gNB 804 to UE 802. Transmission for this radio bearer is allowed in the measurement gaps of the indicated measurement gap configurations.
In one embodiment, transmission of any data of this radio bearer is allowed during these measurement gaps.
In one embodiment, if UE 802 has pending data with remaining a delivery time less than a threshold for this radio bearer, transmission for this radio bearer is allowed during these measurement gaps.
In one embodiment, if UE 802 has a total amount of data available for transmission in the buffer for this radio bearer greater than a threshold, transmission for this radio bearer is allowed during these measurement gaps. The threshold may be signaled by gNB 804 to UE 802.
In one embodiment, if UE 802 has pending data associated with certain QFI(s) in the buffer for this radio bearer, transmission for this radio bearer is allowed during these measurement gaps.
In one embodiment, if UE 802 has pending data (e.g., PDUs of a PDU set) associated with a PDU set delay budget less than a threshold in the buffer for this radio bearer, transmission for this radio bearer is allowed during these measurement gaps. The threshold may be signaled by gNB 804 to UE 802.
In one embodiment, if UE 802 has pending data (e.g., PDUs of a PDU set) associated with certain PDU set importance (PSI) in the buffer for this radio bearer, transmission for this radio bearer is allowed during these measurement gaps. The certain PSIs may be signaled by gNB 804 to UE 802.
In one embodiment, if UE 802 has pending data (e.g., PDUs of a PDU set) associated with a PDU set importance (PSI) less than a threshold in the buffer for this radio bearer, transmission for this radio bearer is allowed during these measurement gaps. The threshold may be signaled by gNB 804 to UE 802.
In one embodiment, if UE 802 has pending data (e.g., PDUs of a PDU set) associated with a PDU set importance (PSI) greater than a threshold in the buffer for this radio bearer, transmission for this radio bearer is allowed during these measurement gaps. The threshold may be signaled by gNB 804 to UE 802.

In one embodiment, this indication can be per cell group. For example, gNB 804 can signal a list of LCHs/RBs for which transmission is allowed during a measurement gap:
allowedTxInMG-List-r19 SEQUENCE (SIZE (0 . . . X)) OF LogicalChannelIdentity;
   or
allowedTxInMG-List-r19 SEQUENCE (SIZE (0 . . . X)) OF DRB-Identity.
   If this list of LCHs/RBs for which transmission is allowed during a measurement gap is received:
In one embodiment, transmission for these DRBs/LCHs is allowed in all measurement gaps by default.
In one embodiment, a list of one or more measurement gap IDs of measurement gap configurations during which UE 802 is allowed to transmit for these DRBs/LCHs is signaled by gNB 804 to UE 802. Transmission for these DRBs/LCHs is allowed in the measurement gaps of the indicated measurement gap configurations.
In one embodiment, transmission of any data of these DRBs/LCHs is allowed during these measurement gaps.
In one embodiment, if UE 802 has pending data with a remaining delivery time less than a threshold for these DRBs/LCHs, transmission for these DRBs/LCHs is allowed during these measurement gaps.
In one embodiment, if UE 802 has a total amount of data available for transmission in a buffer for these DRBs/LCHs greater than a threshold, transmission for these DRBs/LCHs is allowed during these measurement gaps. The threshold may be signaled by gNB 804 to UE 802.
In one embodiment, if UE 802 has pending data associated with certain QFI(s) in the buffer for these DRBs/LCHs, transmission for these DRBs/LCHs is allowed during these measurement gaps.
In one embodiment, if UE 802 has pending data (e.g., PDUs of a PDU set) associated with a PDU set delay budget less than a threshold in the buffer for these DRBs/LCHs, transmission for these DRBs/LCHs is allowed during these measurement gaps. The threshold may be signaled by gNB 804 to UE 802.
In one embodiment, if UE 802 has pending data (e.g., PDUs of a PDU set) associated with a certain PDU set importance (PSI) in the buffer for these DRBs/LCHs, transmission for these DRBs/LCHs is allowed during these measurement gaps. The certain PSIs may be signaled by gNB 804 to UE 802.
In one embodiment, if UE 802 has pending data (e.g., PDUs of a PDU set) associated with a PDU set importance (PSI) less than a threshold in the buffer for these DRBs/LCHs, transmission for these DRBs/LCHs is allowed during these measurement gaps. The threshold may be signaled by gNB 804 to UE 802.
In one embodiment, if UE 802 has pending data (e.g., PDUs of a PDU set) associated with a PDU set importance (PSI) greater than a threshold in the buffer for these DRBs/LCHs, transmission for these DRBs/LCHs is allowed during these measurement gaps. The threshold may be signaled by gNB 804 to UE 802.

In one embodiment, this indication can be per measurement gap. For example, gNB 804 can signal a list of LCHs/RBs for which transmission is allowed during a measurement gap in the corresponding measurement gap configuration:
MeasGapConfig□allowedTxInMG-List-r19 SEQUENCE (SIZE (0 . . . X)) OF LogicalChannelIdentity
   or
MeasGapConfig□allowedTxInMG-List-r19 SEQUENCE (SIZE (0 . . . X)) OF DRB-Identity
   If this list of LCHs/RBs for which transmission is allowed during a measurement gap is received in a measurement gap configuration:
In one embodiment, transmission for these DRBs/LCHs is allowed in a measurement gap of this measurement gap configuration.
In one embodiment, transmission of any data of these DRBs/LCHs is allowed in a measurement gap of this measurement gap configuration.
In one embodiment, if UE 802 has pending data with a remaining delivery time less than a threshold for these DRBs/LCHs, transmission for these DRBs/LCHs is allowed in a measurement gap of this measurement gap configuration.
In one embodiment, if UE 802 has a total amount of data available for transmission in the buffer for these DRBs/LCHs greater than a threshold, transmission for these DRBs/LCHs is allowed in a measurement gap of this measurement gap configuration. The threshold may be signaled by gNB 804 to UE 802.
In one embodiment, if UE 802 has pending data associated with certain QFI(s) in the buffer for these DRBs/LCHs, transmission for these DRBs/LCHs is allowed in a measurement gap of this measurement gap configuration.
In one embodiment, if UE 802 has pending data (e.g., PDUs of a PDU set) associated with a PDU set delay budget less than a threshold in the buffer for these DRBs/LCHs, transmission for these DRBs/LCHs is allowed in a measurement gap of this measurement gap configuration. The threshold may be signaled by gNB 804 to UE 802.
In one embodiment, if UE 802 has pending data (e.g., PDUs of a PDU set) associated with a certain PDU set importance (PSI) in the buffer for these DRBs/LCHs, transmission for these DRBs/LCHs is allowed in a measurement gap of this measurement gap configuration. The certain PSIs may be signaled by gNB 804 to UE 802.
In one embodiment, if UE 802 has pending data (e.g., PDUs of a PDU set) associated with a PDU set importance (PSI) less than a threshold in the buffer for these DRBs/LCHs, transmission for these DRBs/LCHs is allowed in a measurement gap of this measurement gap configuration. The threshold may be signaled by gNB 804 to UE 802.
In one embodiment, if UE 802 has pending data (e.g., PDUs of a PDU set) associated with a PDU set importance (PSI) greater than a threshold in the buffer for these DRBs/LCHs, transmission for these DRBs/LCHs is allowed in a measurement gap of this measurement gap configuration. The threshold may be signaled by gNB 804 to UE 802.

In one embodiment, this indication can be per PDU set type or PDU set priority. If this indication is received for a PDU set type or PDU set priority:
In one embodiment, transmission for data associated with this PDU set type or PDU set priority is allowed in all measurement gaps by default.
In one embodiment, a list of one or more measurement gap IDs of measurement gap configurations during which UE 802 is allowed to transmit for this PDU set type or PDU set priority is signaled by gNB 804 to UE 802. Transmission for this PDU set type or PDU set priority is allowed in the measurement gaps of indicated measurement gap configurations.
In one embodiment, transmission of any data of this PDU set type or PDU set priority is allowed in measurement gaps.
In one embodiment, if UE 802 has pending data with a remaining delivery time less than a threshold for this PDU set type or PDU set priority, transmission for these is allowed in measurement gaps.
In one embodiment, if UE 802 has total amount of data available for transmission in the buffer for this PDU set type or PDU set priority greater than a threshold, transmission for this PDU set type or PDU set priority is allowed in measurement gaps. The threshold may be signaled by gNB 804 to UE 802.

In one embodiment, this indication can be per LCH priority. If this indication is received for an LCH priority:
In one embodiment, transmission for data associated with this LCH priority is allowed in all measurement gaps by default.
In one embodiment, a list of one or more measurement gap IDs of measurement gap configurations during which UE 802 is allowed to transmit is signaled by gNB 804 to UE 802. Transmission for this LCH priority is allowed in the measurement gaps of the indicated measurement gaps.
In one embodiment, a list of one or more measurement gap IDs of measurement gaps during which UE 802 is allowed to transmit for this LCH priority is signaled by gNB 804 to UE 802. Transmission for this LCH priority is allowed in the indicated measurement gaps.
In one embodiment, transmission of any data of LCH(s) associated with this LCH priority is allowed during these measurement gaps.
In one embodiment, if UE 802 has pending data with a remaining delivery time less than a threshold for LCH(s) associated with this LCH priority, transmission for these LCH(s) are allowed during these measurement gaps.
In one embodiment, if UE 802 has total amount of data available for transmission in the buffer for LCH(s) associated with this LCH priority greater than a threshold, transmission for these LCH(s) is allowed during these measurement gaps. The threshold may be signaled by gNB 804 to UE 802.
In one embodiment, if UE 802 has pending data associated with certain QFI(s) in the buffer of LCH(s) associated with this LCH priority, transmission for these LCH(s) is allowed during these measurement gaps.
In one embodiment, if UE 802 has pending data (e.g., PDUs of a PDU set) associated with a PDU set delay budget less than a threshold in the buffer of LCH(s) associated with this LCH priority, transmission for these LCH(s) is allowed during these measurement gaps. The threshold may be signaled by gNB 804 to UE 802.
In one embodiment, if UE 802 has pending data (e.g., PDUs of a PDU set) associated with a certain PDU set importance (PSI) in the buffer of LCH(s) associated with this LCH priority, transmission for these LCH(s) is allowed during these measurement gaps. The certain PSIs may be signaled by gNB 804 to UE 802.
In one embodiment, if UE 802 has pending data (e.g., PDUs of a PDU set) associated with a PDU set importance (PSI) less than a threshold in the buffer for LCH(s) associated with this LCH priority, transmission for these LCH(s) is allowed during these measurement gaps. The threshold may be signaled by gNB 804 to UE 802.
In one embodiment, if UE 802 has pending data (e.g., PDUs of a PDU set) associated with a PDU set importance (PSI) greater than a threshold in the buffer for LCH(s) associated with this LCH priority, transmission for these LCH(s) is allowed during these measurement gaps. The threshold may be signaled by gNB 804 to UE 802.

In one embodiment, this indication can be per LCG. If this indication is received for an LCG:
In one embodiment, transmission for data associated with this LCG is allowed in all measurement gaps by default.
In one embodiment, a list of one or more measurement gap IDs of measurement gaps during which UE 802 is allowed to transmit is signaled by gNB 804 to UE 802. Transmission for this LCG is allowed in the indicated measurement gaps.
In one embodiment, a list of one or more measurement gap IDs of measurement gap configurations during which UE 802 is allowed to transmit for this LCG is signaled by gNB 804 to UE 802. Transmission for this LCG is allowed in the measurement gaps of the indicated measurement gaps.
In one embodiment, transmission of any data of LCH(s) associated with this LCG is allowed during these measurement gaps.
In one embodiment, if UE 802 has pending data with a remaining delivery time less than a threshold for LCH(s) associated with this LCG, transmission for these LCH(s) are allowed during these measurement gaps.
In one embodiment, if UE 802 has a total amount of data available for transmission in the buffer for LCH(s) associated with this LCG greater than a threshold, transmission for these LCH(s) is allowed during these measurement gaps. The threshold may be signaled by gNB 804 to UE 802.
In one embodiment, if UE 802 has pending data associated with certain QFI(s) in the buffer of LCH(s) associated with this LCG, transmission for these LCH(s) is allowed during these measurement gaps.
In one embodiment, if UE 802 has pending data (e.g., PDUs of a PDU set) associated with a PDU set delay budget less than a threshold in the buffer of LCH(s) associated with this LCG, transmission for these LCH(s) is allowed during these measurement gaps. The threshold may be signaled by gNB 804 to UE 802.
In one embodiment, if UE 802 has pending data (e.g., PDUs of a PDU set) associated with a certain PDU set importance (PSI) in the buffer of LCH(s) associated with this LCG, transmission for these LCH(s) is allowed during these measurement gaps. The certain PSIs may be signaled by gNB 804 to UE 802.
In one embodiment, if UE 802 has pending data (e.g., PDUs of a PDU set) associated with a PDU set importance (PSI) less than a threshold in the buffer for LCH(s) associated with this LCG, transmission for these LCH(s) is allowed during these measurement gaps. The threshold may be signaled by gNB 804 to UE 802.
In one embodiment, if UE 802 has pending data (e.g., PDUs of a PDU set) associated with a PDU set importance (PSI) greater than threshold in the buffer for LCH(s) associated with this LCG, transmission for these LCH(s) is allowed during these measurement gaps. The threshold may be signaled by gNB 804 to UE 802.

In one embodiment, this indication can be per QFI. If this indication is received for a QFI.
In one embodiment, transmission for data associated with this QFI is allowed in all measurement gaps by default.
In one embodiment, a list of one or more measurement gap IDs of measurement gaps during which UE 802 is allowed to transmit is signaled by gNB 804 to UE 802. Transmission for this QFI is allowed in the indicated measurement gaps.
In one embodiment, a list of one or more measurement gap IDs of measurement gap configurations during which UE 802 is allowed to transmit for this QFI is signaled by gNB 804 to UE 802. Transmission for this QFI is allowed in the measurement gaps of the indicated measurement gap configurations.
In one embodiment, transmission of any data of this QFI is allowed during these measurement gaps.
In one embodiment, if UE 802 has pending data with a remaining delivery time less than a threshold for this QFI, transmission for this QFI is allowed during these measurement gaps.
In one embodiment, if UE 802 has a total amount of data available for transmission in the buffer for this QFI greater than a threshold, transmission for this QFI is allowed during these measurement gaps. The threshold may be signaled by gNB 804 to UE 802.

In an embodiment, this indication can be per PDU session. If this indication is received for a PDU session:
In one embodiment, transmission for data associated with this PDU session is allowed in all measurement gaps by default.
In one embodiment, a list of one or more measurement gap IDs of measurement gaps during which UE 802 is allowed to transmit is signaled by gNB 804 to UE 802. Transmission for this PDU session is allowed in the indicated measurement gaps.
In one embodiment, a list of one or more measurement gap IDs of measurement gaps during which UE 802 is allowed to transmit for this PDU session is signaled by gNB 804 to UE 802. Transmission for this PDU session is allowed in the measurement gaps of the indicated measurement gap configurations.
In one embodiment, transmission of any data of this PDU session is allowed during these measurement gaps.
In one embodiment, if UE 802 has pending data with a remaining delivery time less than a threshold for this PDU session, transmission for this PDU session is allowed during these measurement gaps.
In one embodiment, if UE 802 has total amount of data available for transmission in the buffer for this PDU session greater than threshold, transmission for this PDU session is allowed during these measurement gaps. The threshold may be signaled by gNB 804 to UE 802.

In one embodiment, if the network (gNB 804) indicates that UE 802 is allowed to transmit in UL (or transmit UL SCH) in the MG duration, UE 802 can perform transmission (allowed transmission as determined earlier) during a measurement gap by default, or UE 802 can perform transmission (allowed transmission as determined earlier) during a measurement gap if transmission during a measurement gap is activated. The activation/deactivation transmission during a measurement gap can be initiated using DCI or a MAC CE. The activation/deactivation can be common for all measurement gap configurations or it can per measurement gap configuration.

In one embodiment, UE 802 indicates to the network (gNB 804) its capability to receive in DL (or receive PDCCH/DL-SCH) during the measurement gap. This UE capability may be indicated by UE 802 to the network (gNB 804) in the RRC_CONNNCTED state or during the connection setup or connection resume procedure. This UE capability may be indicated by UE 802 to the network (gNB 804) in an RRC message (e.g., UE assistance information message, UE capability information message or any other RRC message). This UE capability may be indicated by UE 802 to the network (gNB 804) in a MAC CE. This UE capability may be indicated by UE 802 to the network (gNB 804) using a scheduling request (PUCCH) wherein the scheduling request configuration for indicating this capability can be signaled by the network (gNB 804) to UE 802 (e.g., in an RRCReconfiguration message). In one embodiment, UE 802 may indicate this capability to the network (gNB 804) in response to a UE capability request from the network (gNB 804). In one embodiment, UE 802 may indicate this capability to the network (gNB 804) upon entering the RRC_CONNECTED state (from the RRC IDLE/RRC INACTIVE sate). In an embodiment, UE 802 may indicate this capability to the network (gNB 804) upon handover.

In some embodiments, the network (gNB 804) indicates that UE 802 is allowed to receive in DL (or receive PDCCH/DL-SCH) during the MG duration. Based on the received indication UE 802 receives in DL (or receives PDCCH/DL-SCH) during the MG duration. Such indication may be provided to UE(s) which support DL (or PDCCH/DL-SCH) reception during a measurement gap. In one embodiment, reception of DL (or PDCCH/DL-SCH) is allowed in measurement gaps of all measurement gap configurations by default. In one embodiment, a list of one or more measurement gap IDs of measurement gap configurations during which UE 802 is allowed to receive DL (or PDCCH/DL-SCH) is signaled by gNB 804 to UE 802. In one embodiment, an indication to receive DL (or PDCCH/DL-SCH) is signaled per measurement gap configuration. Reception of DL (or PDCCH/DL-SCH) is allowed in the measurement gaps of the indicated measurement gap configurations. UE 802 receives DL (or PDCCH/DL-SCH) in the measurement gaps of indicated measurement gap configuration. In one embodiment, the network may also indicate one or more search spaces for which UE 802 is allowed to receive PDCCH during measurement gaps. If indicated, UE 802 monitors PDCCH corresponding to these search spaces during the measurement gaps where UE 802 is allowed to receive PDCCH.

In one embodiment, the network (gNB 804) can indicate one or more CG configurations for which UL-SCH can be transmitted during a measurement gap. In one embodiment this indication can be per CG configuration. If the CG occasion of CG configurations for which the network (gNB 804) indicates that UL-SCH can be transmitted during a measurement gap occurs during the measurement gap, UE 802 may generate a MAC PDU and transmit in the CG occasion.

In one embodiment, the network (gNB 804) can indicate one or more SR configurations for which SR can be transmitted during a measurement gap. In one embodiment this indication can be per SR configuration. If the SR occasion of the SR configuration for which the network (gNB 804) indicates that SR can be transmitted during a measurement gap occurs during the measurement gap, UE 802 may transmit in the SR occasion if the SR is triggered and pending.

In one embodiment, the network (gNB 804) can indicate in DCI scheduling UL SCH/UL TB whether this UL-SCH/TB can be transmitted during a measurement gap. If scheduled UL SCH resources for the UL TB occurs during a measurement gap and indication to transmit during the measurement gap is received in DCI, UE 802 transmits an UL TB in the scheduled UL-SCH resources. If the scheduled UL SCH resources for the UL TB occurs during a measurement gap and indication to transmit during the measurement gap is not received in DCI, UE 802 does not transmit an UL TB in the scheduled UL-SCH resources.

In one embodiment, the network (gNB 804) can indicate that UE 802 should ignore a measurement gap during the active time of C-DRX. This indication can be per measurement gap configuration or it can be common for all measurement gap configurations. If such an indication is received by UE 802 for measurement gap configuration(s), UE 802 ignores the measurement gap(s) of those configurations during the active time of C-DRX. Ignoring a measurement gap means that a UE will not perform an operation (as described herein) for a measurement gap.

In one embodiment, the network (gNB 804) can indicate that UE 802 should perform UL-SCH transmission during a measurement gap if the UL-SCH is scheduled during the active time of C-DRX. This indication can be per measurement gap. If such an indication is received by UE 802 for measurement gap configuration(s), if the UL-SCH is scheduled during the active time of C-DRX and the scheduled UL-SCH overlaps with a measurement gap of the measurement gap configuration(s), UE 802 performs the UL-SCH transmission.

In one embodiment, the network (gNB 804) can indicate that UE 802 should perform PDCCH monitoring during a measurement gap if the measurement gap occurs during the active time of C-DRX. This indication can be per search space or common for all search spaces. If the indication to monitor PDCCH for search space(s) is received, UE 802 monitors PDCCH in PDCCH monitoring occasions overlapping with a measurement gap for those search space(s). In one embodiment, the measurement gap can be a measurement gap of any measurement gap configuration. In another embodiment, the network can indicate for which measurement gap configuration(s), UE 802 is allowed to monitor PDCCH during a measurement gap. If the indication to monitor PDCCH for search space(s) is received, UE 802 monitors PDCCH in PDCCH monitoring occasions for those search space(s), overlapping with a measurement gap of the indicated measurement gap configuration(s). If the indication to monitor PDCCH for search space(s) is not received, UE 802 does not monitor PDCCH in PDCCH monitoring occasions overlapping with a measurement gap for those search space(s).

UE 802 can be configured with several measurement gap configurations by the network (gNB 804). A measurement gap configuration indicates the measurement gap duration (also referred to as a measurement gap duration or occasion) which occurs periodically (measurement gap period). In one embodiment, RRC signalling from the network (gNB 804) indicates one or more measurement gaps (measurement gap configurations) which can be skipped. RRC signalling from the network (gNB 804) can indicate the measurement gap ID of a measurement gap to be skipped, and UE 802 skips measurement gap occasions/durations of the measurement gap configuration corresponding to the measurement gap ID. RRC signalling from the network (gNB 804) can indicate the gap type (e.g. UE gap, FR1 gap, FR2 gap etc) to be skipped, and UE 802 skips the measurement gap occasions/durations of the measurement gap configuration corresponding to the indicated gap type. RRC signalling from the network (gNB 804) can indicate the gap priority of the gap to be skipped, and UE 802 skips the measurement gap occasions/durations of the measurement gap configuration corresponding to the indicated gap priority. RRC signalling from the network (gNB 804) can indicate the gap priority threshold for skipping, and UE 802 skips measurement gap occasions/durations of the measurement gap configuration with the gap priority above or below can be skipped.

In one embodiment, one bit in a DCI indicates for UE 802 to skip a measurement gap, and UE 802 applies skipping for the gaps configured for skipping via RRC signalling from the network (gNB 804), as explained herein. In another embodiment, multiple bits in a DCI can indicate measurement gap skipping. Each bit corresponds to a gap configured for skipping by RRC signalling from the network (gNB 804). Bits in the DCI can be mapped from least significant bit to most significant bit in increasing order of the measurement gap ID. Bit position in the DCI can be signalled in an RRC for each gap to be skipped. Bits in the DCI can be mapped to and index of entry in a list of gaps to be skipped configured by and RRC, in increasing order of the index.

In one embodiment, one bit in a DCI indicates for UE 802 to skip a measurement gap, and UE 802 applies skipping for all the gaps configured by an RRC.

In one embodiment, upon receiving a DCI for measurement gap skipping, skipping may be applied after an offset from the received DCI. The offset can be signaled by RRC signaling from the network (gNB 804). The offset can be common or can be a per gap configuration to be skipped.

A measurement gap duration/occasion occurs periodically for every configured measurement gap. In one embodiment, upon receiving a DCI for measurement gap skipping, UE 802 skips the first gap occasion occurring at an offset from the end of the indication (DCI). In another embodiment, upon receiving a DCI for measurement gap skipping, UE 802 skips the ‘N’ gap occasions occurring at an offset from the end of the indication (DCI). N is signalled in the DCI or N is signalled via RRC signaling. N can be per gap or common for all gaps to be skipped. In another embodiment, upon receiving a DCI for measurement gap skipping, UE 802 skips all the gap occasions occurring at an offset from the end of the indication (DCI) until another DCI (or MAC CE or RRC) disabling gap skipping is received. In one embodiment, upon receiving a DCI for measurement gap skipping, UE 802 skips the gap occasions in a time window, wherein time window starts from the end of the slot/symbol in which the DCI is received or at an offset from the end of the slot/symbol in which the DCI is received. The length of time window can be signalled by RRC or DCI. The length of the window can be common for all gaps to be skipped or can be per gap to be skipped.

In one embodiment, a measurement gap skipping indication can be separate for enabling allowing transmissions and receptions during a measurement gap. The network (gNB 804) can indicate for the UE to transmit or receive or both during the measurement gap. The indication of allowing transmissions and receptions during the measurement gap can be separate or common.

In one embodiment, if UE 802 is configured with multiple serving cells, if skipping is indicated for a measurement gap, UE 802 can skip gaps in all cells where the gap is applicable. In one embodiment, if UE 802 is configured with multiple serving cells, if skipping is indicated for a measurement gap, UE802 can skip gaps only in the cell from which DCI indicating measurement gap skipping is received. In one embodiment, if UE 802 is configured with multiple serving cells, if skipping is indicated for a measurement gap, cell(s) where skipping is applied is indicated in DCI or RRC.

Although FIG. 8 illustrates one example of UE operation during a measurement gap 800, various changes may be made to FIG. 8. For example, while shown as a series of steps, various steps in FIG. 8 could overlap, occur in parallel, occur in a different order, occur any number of times, be omitted, or replaced by other steps.

As described herein, a UE such as UE 802 may indicate one or more capabilities for relaxed operation to the network upon layer 1 (L1)/layer 2 (L2) triggered mobility (LTM). The present disclosure provides a method for random access (RA) type selection for L1/L2 triggered mobility.

A gNB or base station of Cell A provides the LTM configuration of candidate Cell B. The configuration of candidate Cell B may include an L1 measurement configuration. Cell A is a serving cell and belongs to a MCG, and Cell B is a candidate PCell or SpCell. An RRCReconfiguration IE for Cell B is included in an RRCReconfiguration message received from the gNB or base station of Cell A. The RRCReconfiguration IE for Cell B includes dedicatedSIB1-Delivery and ltm-Config IEs.

The UE confirms the RRC Reconfiguration received from the gNB or base station of Cell A by transmitting an RRCReconfiguration complete message.

After transmitting the RRCReconfiguration complete message, the UE performs L1 measurements of Cell B and reports these to the gNB or base station to which Cell A belongs.

Based on the L1 measurements, the gNB or base station of cell A decides to execute a cell switch to a target cell (i.e., Cell B) and transmits a LTM Cell Switch Command MAC CE triggering the cell switch by including the candidate configuration index of the target cell (i.e., Cell B).

In one embodiment, the UE receives an LTM Cell Switch Command MAC CE from the network (gNB). The UE initiates a random access procedure towards the target cell indicated in the LTM Cell Switch Command MAC CE, and the UE selects BWP(s).

If the Random Access Preamble index field (or alternately, the Random Access Preamble index field is not equal to zero) has been explicitly provided by the LTM Cell Switch Command MAC CE or by, the UE sets the RA_TYPE to 4-stepRA. Otherwise (i.e., the Random Access Preamble index field has not been explicitly provided by the LTM Cell Switch Command MAC CE), if the BWP selected for the Random Access procedure is configured with both 2-step and 4-step RA type Random Access Resources and the RSRP of the downlink pathloss reference is above msgA-RSRP-Threshold, or if the BWP selected for the Random Access procedure is only configured with 2-step RA type Random Access resources, the UE sets the RA TYPE to 2-stepRA. Otherwise, the UE sets the RA_TYPE to 4-stepRA.

The UE performs initialization of variables specific to the Random Access type. If the RA_TYPE is set to 2-stepRA, the UE performs the Random Access Resource selection procedure for 2-step RA type, and transmits a MsgA (RACH preamble and MsgA MAC PDU). Otherwise, the UE performs the Random Access Resource selection procedure, and transmits a Msg1 (RACH preamble).

In another embodiment, the UE receives an LTM Cell Switch Command MAC CE from the network (gNB). The UE initiates a random access procedure towards the target cell indicated in LTM Cell Switch Command MAC C, and the UE selects BWP(s).

If the contention free random access resource information (e.g., preamble index, ra-ssb-OccasionMasklndex) for 4 step RA has been explicitly provided by the LTM Cell Switch Command MAC CE, the UE sets the RA_TYPE to 4-stepRA. Otherwise, if the BWP selected for Random Access procedure is configured with both 2-step and 4-step RA type Random Access Resources and the RSRP of the downlink pathloss reference is above msgA-RSRP-Threshold, or if the BWP selected for the Random Access procedure is only configured with 2-step RA type Random Access resources, the UE sets the RA_TYPE to 2-stepRA. Otherwise, the UE sets the RA_TYPE to 4-stepRA.

The UE performs initialization of variables specific to the Random Access type. If the RA_TYPE is set to 2-stepRA, the UE performs the Random Access Resource selection procedure for 2-step RA type, and transmits a MsgA (RACH preamble and MsgA MAC PDU). Otherwise, the UE performs the Random Access Resource selection procedure, and transmits a Msg1 (RACH preamble).

In another embodiment, the UE receives an LTM Cell Switch Command MAC CE from the network (gNB). The UE initiates a random access procedure towards the target cell indicated in the LTM Cell Switch Command MAC CE, and the UE selects BWP(s).

If the Random Access Preamble index field has been explicitly provided by the LTM Cell Switch Command MAC CE and a msgA-PUSCH-Resource-Index has not been explicitly provided by the LTM Cell Switch Command MAC CE, the UE sets the RA_TYPE to 4-stepRA. Otherwise, if the BWP selected for Random Access procedure is configured with both 2-step and 4-step RA type Random Access Resources and the RSRP of the downlink pathloss reference is above msgA-RSRP-Threshold, or if the BWP selected for Random Access procedure is only configured with 2-step RA type Random Access resources, or if the msgA-PUSCH-Resource-Index has been explicitly provided by the LTM Cell Switch Command MAC CE, the UE sets the RA_TYPE to 2-stepRA. Otherwise, the UE sets the RA_TYPE to 4-stepRA.

The UE performs initialization of variables specific to the Random Access type. If the RA_TYPE is set to 2-stepRA, the UE performs the Random Access Resource selection procedure for 2-step RA type, and transmits a MsgA (RACH preamble and MsgA MAC PDU). Otherwise, the UE performs the Random Access Resource selection procedure, and transmits a Msg1 (RACH preamble).

In another embodiment, the UE receives an LTM Cell Switch Command MAC CE from the network (gNB). The UE initiates a random access procedure towards the target cell indicated in the LTM Cell Switch Command MAC CE, and the UE selects BWP(s).

If the contention free random access resource information for 4 step RA (e.g., preamble index, ra-ssb-OccasionMasklndex) has been explicitly provided by the LTM Cell Switch Command MAC CE, the UE sets the RA_TYPE to 4-stepRA. Otherwise, if the BWP selected for the Random Access procedure is configured with both 2-step and 4-step RA type Random Access Resources and the RSRP of the downlink pathloss reference is above msgA-RSRP-Threshold, or if the BWP selected for the Random Access procedure is only configured with 2-step RA type Random Access resources, or if the contention free random access resource information (e.g., preamble index, ra-ssb-OccasionMasklndex, msgA-PUSCH-Resource-Index, ssb-SharedRO-MaskIndex) for 2 step RA has been explicitly provided by the LTM Cell Switch Command MAC CE, the UE sets the RA_TYPE to 2-stepRA. Otherwise, the UE sets the RA_TYPE to 4-stepRA.

The UE performs initialization of variables specific to the Random Access type. If the RA_TYPE is set to 2-stepRA, the UE performs the Random Access Resource selection procedure for 2-step RA type, and transmits a MsgA (RACH preamble and MsgA MAC PDU). Otherwise, the UE performs the Random Access Resource selection procedure, and transmits a Msg1 (RACH preamble).

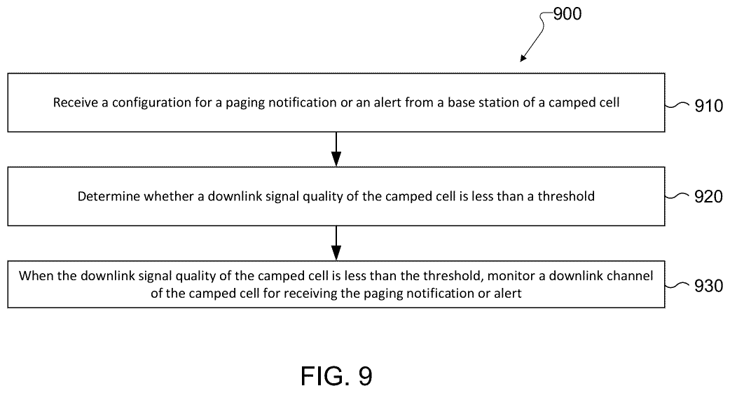

FIG. 9 illustrates an example method for transmitting and receiving a paging notification or alert 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for transmitting and receiving a paging notification or alert could be used without departing from the scope of this disclosure.

In the example of FIG. 9, a UE, such as UE 116 of FIG. 1 is camped in a Cell. At step 910, the UE receives a configuration for a paging notification or an alert from a base station of the camped cell.

At step 920, the UE determines whether a downlink signal quality of the camped cell is less than a threshold.

At step 930, when the downlink signal quality of the camped cell is less than the threshold, the UE monitors a downlink channel of the camped cell for receiving the paging notification or alert.

Although FIG. 9 illustrates one example method for transmitting and receiving a paging notification or alert 900, various changes may be made to FIG. 9. For example, while shown as a series of steps, various steps in FIG. 9 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive a configuration for a paging notification or an alert from a base station of a cell camped on by the UE; and
a processor operably coupled to the transceiver, the processor configured to:
determine whether a downlink signal quality of the camped cell is less than a threshold; and
when the downlink signal quality of the camped cell is less than the threshold, monitor a downlink channel of the camped cell for receiving the paging notification or alert.

2. The UE of claim 1, wherein the processor is further configured to:
determine whether the downlink signal quality of the camped cell meets or exceeds the threshold; and
when the downlink signal quality of the camped cell meets or exceeds the threshold, monitor the downlink channel of the camped cell for receiving a paging.

3. The UE of claim 1, wherein:
the transceiver is further configured to:
receive the paging notification or alert from the base station of the camped cell; and
the processor is further configured to:
in response to the receipt of the paging notification or alert, initiate an alert for a user of the UE to relocate the UE to an area with good cell coverage; and
monitor the downlink channel of the camped cell for receiving a paging.

4. The UE of claim 1, wherein:
the processor is further configured to determine whether the UE and the camped cell support the paging notification or alert; and
the downlink channel of the camped cell is monitored for receiving the paging notification or alert when the UE and the camped cell support the paging notification or alert.

5. The UE of claim 1, wherein:
the transceiver is further configured to receive the paging notification or alert from the base station of the camped cell; and
the processor is further configured to, when the downlink signal quality of the camped cell is less than the threshold, initiate an alert for a user of the UE to relocate the UE to an area with good cell coverage.

6. The UE of claim 1, wherein:
the transceiver is further configured to receive the paging notification or alert from the base station of the camped cell; and
the processor is further configured to:
determine whether the paging notification or alert indicates a specific cell or carrier to monitor for a paging; and
when the paging notification or alert indicates a specific cell or carrier to monitor for the paging, monitor a downlink channel of the indicated cell or carrier for receiving the paging.

7. The UE of claim 6, wherein the processor is further configured to, when the paging notification or alert fails to indicate a specific cell or carrier to monitor for the paging:
initiate an alert for a user of the UE to relocate the UE to an area with good cell coverage; and
monitor the downlink channel of the camped cell for receiving the paging.

8. A base station (BS) comprising:
a processor; and
a transceiver operatively coupled to the processor, the transceiver configured to:
transmit a configuration for a paging notification or an alert to a user equipment (UE) camped on a cell of the base station; and
transmit the paging notification or alert to the UE.

9. The BS of claim 8, wherein the transceiver is further configured to transmit a paging to the UE.

10. The BS of claim 8, wherein:
the transceiver is further configured to transmit, to the UE, a message indicating that the BS supports the paging notification or alert.

11. The BS of claim 10, wherein the message is one of a system information (SI) or radio resource control (RRC) message.

12. The BS of claim 8, wherein the paging notification or alert indicates a specific cell or carrier to monitor for a paging.

13. The BS of claim 12, wherein the transceiver is further configured to transmit a paging to the UE on the specific cell or carrier.

14. A method of operating a user equipment (UE), the method comprising:
receiving a configuration for a paging notification or an alert from a base station of a cell camped on by the UE;
determining whether a downlink signal quality of the camped cell is less than a threshold; and
when the downlink signal quality of the camped cell is less than the threshold, monitoring a downlink channel of the camped cell for receiving the paging notification or alert.

15. The method of claim 14, further comprising:
determining whether the downlink signal quality of the camped cell meets or exceeds the threshold; and
when the downlink signal quality of the camped cell meets or exceeds the threshold, monitoring the downlink channel of the camped cell for receiving a paging.

16. The method of claim 14, further comprising:
receiving the paging notification or alert from the base station of the camped cell;
in response to the receipt of the paging notification or alert, initiating an alert for a user of the UE to relocate the UE to an area with good cell coverage; and
monitoring the downlink channel of the camped cell for receiving a paging.

17. The method of claim 14, further comprising:
determining whether the UE and the camped cell support the paging notification or alert; and
when the UE and the camped cell support the paging notification or alert, monitoring the downlink channel of the camped cell for receiving the paging notification or alert.

18. The method of claim 14, further comprising:
receiving the paging notification or alert from the base station of the camped cell; and
when the downlink signal quality of the camped cell is less than the threshold, initiating an alert for a user of the UE to relocate the UE to an area with good cell coverage.

19. The UE of claim 14, further comprising:
receiving the paging notification or alert from the base station of the camped cell;
determining whether the paging notification or alert indicates a specific cell or carrier to monitor for a paging; and
when the paging notification or alert indicates a specific cell or carrier to monitor for the paging, monitoring a downlink channel of the indicated cell or carrier for receiving the paging.

20. The UE of claim 19, further comprising, when the paging notification or alert fails to indicate a specific cell or carrier to monitor for the paging:
initiating an alert for a user of the UE to relocate the UE to an area with good cell coverage; and
monitoring the downlink channel of the camped cell for receiving the paging.
